(19) United States
(12) Patent Application Publication
(10) Pub. No.: US 2026/0120008 A1
(43) Pub. Date: Apr. 30, 2026

(54) PERSONALIZED PRODUCTIVITY ASSISTANT SYSTEM

(71) Applicant: Oracle International Corporation, Redwood Shores, CA (US)

(72) Inventor: Navendu Jain, Snohomish, WA (US)

(73) Assignee: Oracle International Corporation, Redwood Shores, CA (US)

(21) Appl. No.: 18/926,052

(22) Filed: Oct. 24, 2024

(51) Int. Cl. G06Q 10/0631

(52) U.S. Cl. CPC G06Q 10/0631

(57) ABSTRACT

A Productivity Assistant System (PAS) is described that uses specially-trained ML models (e.g., artificial neural networks (ANNs)) to predict a next action to be performed for a sequence of interactions made by a user with one or more applications or services. The predicted action is customized to that user or to a group of users to which the user belongs. Techniques are described for training and using one or more such machine learning models.

### FIELD

The present disclosure relates generally to machine learning (ML) techniques. More particularly, a Productivity Assistant System (PAS) is described that uses specially-trained ML models (e.g., artificial neural networks (ANNs)) to predict a next action to be performed for a user given a sequence of interactions made by the user with one or more applications or services. The predicted action is customized for that user or for a group of users to which the user belongs. Techniques are described for training and using one or more such machine learning models.

### BACKGROUND

The adoption of artificial intelligence (AI) and machine learning (ML)-based techniques has completely reshaped the manner in which technology impacts human behavior and activities. For example, ML-based models, such as various generative language models including large language models (LLMs), offer promising solutions for various scenarios such as customer support, software development, content generation, and others. The present ML techniques and models still have several limitations. For example, the interactivity with existing models requires explicit input from the user such as via a prompt and/or a query provided to an LLM. Even in an ML system that uses Retrieval-Augmented Generation (RAG) techniques, the search results have to be fed to a RAG model that is then used to answer user-entered queries. These models fall short for personalized scenarios where explicit user input is not provided or where user preferences or customizations need to be taken into account for output predictions. Current ML models are also trained on static datasets and generate generic outputs that are not personalized for a user or groups of users and do not adapt over time.

### BRIEF SUMMARY

The present disclosure relates generally to machine learning (ML) techniques. More particularly, a Productivity Assistant System (PAS) is described that uses specially-trained ML models (e.g., artificial neural networks (ANNs)) to predict a next action to be performed for a user given a sequence of interactions made by the user with one or more applications or services. The predicted action is customized for that user or for a group of users to which the user belongs. Techniques are described for training and using one or more such machine learning models.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

According to certain embodiments. a PAS is described that can execute a method comprising: receiving interactions data for a first set of one or more users, the interactions data identifying interactions made by the first set of one or more users with one or more applications or services; identifying a sequence of interactions from the interactions data, the sequence of interactions comprising a temporally-ordered set of one or more related interactions; using a trained machine learning (ML) model to generate an output that identifies an action to be performed after the one or more interactions in the sequence of interactions, wherein the trained ML model is trained using interactions made by a second set of users with the one or more applications or services; and causing the action to be performed, wherein the action is performed in a particular application or particular service from the one or more applications or services. The output generated by PAS using the trained ML model may identify the particular application or the particular service. The trained ML model may be a trained artificial neural network (ANN).

In certain use cases, the first set of users is different from the second set of users and the sequence of interactions is for a user not included in the second set of users. In some other use cases, the identified sequence of interactions may be for a user included in the second set of users.

In certain embodiments, the PAS may identify a second sequence of interactions comprising the one or more interactions in the sequence of interactions identified from the interactions data followed by the action that is performed. The PAS may the trained machine learning (ML) model to generate a new output that identifies a new action to be performed based the interactions in the second sequence of interactions.

The PAS may use different techniques to generate an output that identifies an action to be performed. In certain implementations, the PAS may generate a prompt comprising the sequence of interactions, and a request to identify a next action to be performed after the sequence of interactions. The PAS may then provide the prompt as input to the trained ML model. Responsive to the prompt, the trained ML model may predict the action to be performed after the one or more interactions in the sequence of interactions. In some instances, using the trained ML model to generate the output may comprise: generating a sequence of vector embeddings for the sequence of interactions, the sequence of vector embeddings comprising a vector embedding for each is in the sequence of interactions; and identifying, a stored set of sequences of vector embeddings, a matching sequence of vector embeddings that matches the sequence of embeddings generated for the sequence of interactions, wherein the stored set of sequences of vector embeddings correspond to sequences of interactions used for training a ML model to generate the trained ML model. The matching sequence of vector embeddings may be included in the prompt.

The prompt that is generated may also include additional information that is used for predicting the action. This information may include information identifying preferences related to one or more users from the first set of users, wherein the preferences affect the output generated by the PAS using the trained ML model.

There are different ways in which the PAS may receive the interactions data for the first set of one or more users. In certain embodiments, the PAS may receive the interactions data from an observer framework, wherein the observer framework observes and collects data related to interactions made by first set of users with the one or more applications or services. The observer framework may comprise at least one of a tool for recording keystrokes input by the first set of users, a tool for recording mouse clicks input by the first set of users, a tool for capturing eye gazes of the first set of users, a screen scraping tool, a web scraping tool, a screen recording tool, or a tool for capturing a video of the interactions made by the first set of users with the one or more applications. The sequence of interactions may include a first interaction made with a first application or service in the one or more applications or services and a second interaction made with a second application or service in the one or more applications or services.

The PAS may use different techniques to identify the sequence of interactions from the interactions data. In certain implementations, the processing may include: determining, by the PAS, for each interaction in the sequence of interactions: information identifying the interaction, temporal data associated with the interaction, information identifying an application or service from the one or more applications or services with which the interaction was made, and context data associated with the interaction.

The PAS uses a trained ML model to generate an output that identifies an action to be performed after the one or more interactions in the sequence of interactions. Different training and/or fine tuning techniques may be used to generate the trained ML model from a ML model. In certain implementations, the training or fine tuning may include: receiving training interactions data for the second set of one or more users, the training interactions data identifying interactions made by the second set of one or more users with the one or more applications or services; identifying sequences of interactions from the training interactions data, each sequence in the sequences of interactions comprising a temporally-ordered set of one or more related interactions; and training the ML model using the multiple sequence of interactions to generate the trained ML model, wherein the trained ML model is trained to predict a next action to be performed for a sequence of interactions and to generate sequences of embeddings for the sequences of interactions.

In certain implementations, training or fine tuning the ML model may further include: storing the sequences of embeddings generated for the sequences of interactions; identifying information related to a set of target users, wherein the set of target users includes users for whom the ML model is being trained; and using the information related to the set of target users to train the ML model.

The trained ML model may be retrained or re-fine-tuned responsive to various triggers or conditions. These triggers or conditions may include, for example: availability of additional user interactions data since the training of the trained ML model, performance of the trained ML model drops below an acceptable threshold, the trained ML model is to be trained for a new application or service that was not included in training data used to train the trained ML model, a change is detected in a pattern of user interactions from user interactions in the training data that was used to train the trained ML model, or passage of a certain period of time since the trained ML model was previously trained.

After the ML model has generated an output identifying an action to be performed, the PAS may perform processing to determine if the action is to be performed. Based upon the processing, the PAS may determine that the action is to be performed only upon receiving input authorizing performance of the action or that the action is to be performed without receiving any user input. Upon determining that action is to be performed only upon receiving input authorizing performance of the action, the PAS may output information seeking authorization for performance of the action. The PAS may then cause the action to be performed upon receiving the requisite input authorizing performance of the action. Upon determining that the action is to be performed without receiving any user input, the PAS may cause the action to be performed without receiving any user input. In certain use cases, the PAS may determine not to perform the action, in which case, the action is not performed.

Various factors may influence whether or not an action is to be performed, and if it is to be performed, whether it is to be performed without out without receiving user authorization. For example, the PAS may determine one or more information pieces, and then, based upon the one or more information pieces, determine whether the action is to be performed only upon receiving input authorizing performance of the action or that the action is to be performed without receiving any user input, or not to be performed. The one or more information pieces may include, for example, at least one of: user preferences information configured for a user associated with the sequence of interactions, the user preferences information identifying if the action is to be performed only upon receiving user input authorizing performance of the action or if the action is to be performed without receiving any user input; information identifying a confidence level, wherein the action is to be performed without receiving any user input if a confidence level associated with prediction of the action is above the identified confidence level; information identifying a risk level associated with the action; information identifying a permission associated with the action, wherein the permission indicates whether the action is to be performed only upon receiving user input authorizing performance of the action or if the action is to be performed without receiving any user input; or information identifying a mode of operation of the PAS, wherein the mode indicates whether the action is to be performed only upon receiving user input authorizing performance of the action or if the action is to be performed without receiving any user input.

In certain implementations, when an action is to be performed, the PAS may cause the action to be performed by calling one or more application programming interface (API) provided by the particular application or by the particular service where the action is to be performed.

In certain implementations, the PAS may be implemented using a system comprising a memory storing a set of instructions, and a set of one or more processors configured to execute the set of instructions. In certain implementations, a non-transitory computer-readable medium may be provided storing instructions executable by the one or more processors. Execution of the set of instructions by the one or more processors may cause the following processing to be performed: receiving interactions data for a first set of one or more users, the interactions data identifying interactions made by the first set of one or more users with one or more applications or services; identifying a sequence of interactions from the interactions data, the sequence of interactions comprising a temporally-ordered set of one or more related interactions; using a trained machine learning (ML) model to generate an output that identifies an action to be performed after the one or more interactions in the sequence of interactions, wherein the trained ML model is trained using interactions made by a second set of users with the one or more applications or services; and performing processing to determine if the action is to be not performed, is to be performed only upon receiving input authorizing performance of the action, or is to be performed without receiving any user input; not performing the action upon determining that the action is not to be performed; upon determining that action is to be performed only upon receiving input authorizing performance of the action: requesting an authorization for performance of the action, receiving input authorizing performance of the action, and causing the action to be performed upon receiving the input authorizing performance of the action; and upon determining that the action is to be performed without receiving any user input: causing the action to be performed.

The foregoing, together with other features and embodiments will become more apparent upon referring to the following specification, claims, and accompanying drawings.

### BRIEF DESCRIPTION OF THE DRAWINGS

The specification refers to the following figures:

FIG. 1 depicts a simplified flowchart depicting processing performed for training a machine learning (ML) model such as an artificial neural network (ANN) to predict actions according to certain embodiments.

FIG. 2A is a simplified block diagram of a distributed environment incorporating a system for training an ML model (e.g., an ANN) for use by the PAS according to certain embodiments.

FIG. 2B is a simplified block diagram of a distributed environment incorporating another system for training an ML model (e.g., an ANN) for use by the PAS according to certain embodiments.

FIG. 3 depicts a simplified high level flowchart depicting processing performed for using a trained ML model (e.g., a trained ANN) for predicting actions for one or more users and for causing one or more of the predicted actions to be performed or executed according to certain embodiments.

FIG. 4 depicts a simplified high level flowchart depicting an example of processing that may be performed in 314 in FIG. 3 for using a trained ML model (e.g., an ANN) to predict a next action according to certain embodiments.

FIG. 5 is a simplified block diagram of a distributed environment incorporating a Productivity Assistant System (PAS) that uses a trained ML model (e.g., a trained ANN) to predict actions to be performed for one or more users and then, if appropriate, causes the predicted actions to be performed according to certain embodiments.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to machine learning (ML) techniques. More particularly, a Productivity Assistant System (PAS) is described that uses specially-trained ML models (e.g., artificial neural networks (ANNs)) to predict a next action to be performed for a user given a sequence of interactions made by the user with one or more applications or services. The predicted action can be customized for that user or for a group of users to which the user belongs. Techniques are described for training and using one or more such machine learning models.

In certain embodiments, interactions made by one or more users with one or more applications or services are observed and data collected for the interactions. The user interactions data is then used to train an ML model such that, given a sequence of interactions with the applications or services, the trained ML model can predict a next action to be performed after the last interaction in the sequence of interactions. The trained ML model is then used by the PAS during runtime inferencing for predicting actions for one or more users. For example, a user's interactions with one or more applications or services may be observed and user interactions data collected for the interactions. A sequence of interactions may be identified from the user interactions data, where the sequence includes one or more interactions that are semantically related to each other. The PAS may then use the trained ML model to predict a next action to be performed after the one or more interactions in the sequence of interactions. The PAS predicts the action without requiring any intervention or input from the user.

After predicting an action, the PAS may perform processing to determine if the predicted action is to be performed. In some instances, the PAS may cause the predicted action to be performed automatically without receiving or requiring any user input. In some other instances, the PAS may seek authorization from the user for performing the predicted action and perform the predicted action only upon receiving the user's authorization. In some other instances, PAS may determine, based upon the circumstances, that the predicted action is not to be performed.

The PAS may be implemented and used in various different environments. For example, the PAS may be implemented on a personal computer used by a user, in a distributed system, in an enterprise system used by users in the enterprise, in a cloud setting (e.g., in a data center) serving subscribers of cloud services, and the like.

Various different types of ML models may be trained and used by the PAS. For example, in certain embodiments, one or more artificial neural networks (ANNs) may be trained and used. Examples of ANNs include various language models (LMs) including large language models (LLMs). An LLM is a type of language model and is characterized by a large-scale (size of data corpus), transformer architecture, and natural language processing (NLP) applications (e.g., can understand and generate language content). Examples of LLMs include various versions of Generative Pre-trained Transformer (GPT) models (e.g., GPT-3, GPT-4, etc.) developed by OpenAI, versions of LLaMA model provided by Meta, versions of Claude provided by Anthropic, versions of BERT (Bidirectional Encoder Representations from Transformers) model provided by Google, and others. Various different training and/or fine-tuning techniques may be used to train an ANN, including masked language modelling (MLM) training techniques, various fine tuning techniques for fine tuning large language models (LLMs), reinforcement training techniques, and others, and combinations of these techniques.

A user may interact with the applications or services using one or more devices associated with the user, referred to as user devices. Examples of user devices include one or more of a laptop used by the user, the users mobile device (e.g., a mobile phone, a tablet), a game console and associated screen used by the user, and the like. The user interactions may be monitored on a continuous basis over a period of time. In certain implementations, an observer framework is provided for observing and collecting data related to interactions made by users with one or more applications or services. The observer framework can include one or more agents or tools configured to monitor users interactions and collect data related to the interactions. The interactions that are observed and tracked can take various forms such as keystrokes input by a user using a user device, eye gazes of the user while viewing certain applications or screens of an application, mouse inputs made by the user, and the like. Various different tools and techniques may be provided as part of the observer framework to observe and capture these interactions. For example, tools may be provided such as a video capture tools for capturing a video of user interactions and subsequent analysis of the video to identify specific interactions, a keystroke logger or capture tool, an eye gaze tracking tool, a mouse input tracker tool, a screen/web scraping tool, a screencast/screen recording tool, and the like. The collected interactions data may be stored as user-application interaction logs. The interactions data is then used to train the ML model.

Examples of applications that a user can interact with include applications for opening reading and sending emails (e.g. Microsoft Outlook), browsers (e.g., Apple Safari, Google Chrome, Microsoft Edge), applications for editing documents (e.g., Microsoft WORD), applications for presentations (e.g., Microsoft PowerPoint), applications that enable collaboration such as for creating and managing websites and content (e.g., Microsoft Sharepoint), messaging applications (e.g., Zoom, Slack, Microsoft Teams, Cisco Webex), applications for creating and editing images (e.g., various applications provided by Adobe), spreadsheet applications (e.g., MS Excel), code Integrated Development Environments (IDEs) (e.g., NetBeans, Eclipse, IntelliJ, Visual Studio), and the like. A user can also interact with various services including one or more cloud services offered by a cloud services provider (CSP). The applications or services may be executed by on a user device or system, computers that are remoted from the user system (e.g., enterprise servers), by infrastructure (e.g., data centers) provided by a cloud service provider (CSP), and on other hosts and platforms.

The PAS is able to predict actions to be performed without receiving any specific user inputs such as prompts or queries. The actions predicted for a user are based upon interactions made by the user with one or more applications or services and are personalized for the user. This saves significant time and energy for users leading to significant increases in task efficiency, and productivity gains for users while reducing manual effort on the users'part.

The trained ML model is also dynamically adapted to account for changes in users behaviors, in response to new users interactions, in response to new applications or services being observed, or in response to degradation in the model's performance. Interactions may be continuously monitored, and the ML model updated on a periodic basis. In this manner, the model is continually trained on the latest user interactions. The model can be updated and fine-tuned periodically or incrementally. In certain implementations, the model may be updated and fine-tuned when the error rate for the model exceeds a configurable threshold to ensure constant adaptation with minimal data and computational resources.

For purposes of this disclosure, it is assumed that privacy of users is strictly maintained when users-related data is captured, stored, and/or used. For example, interactions data for a user is captured and used only after receiving explicit approval from the user to do so. Likewise, user preferences data is captured, stored, and/or used only upon receiving explicit approval from the user to do so.

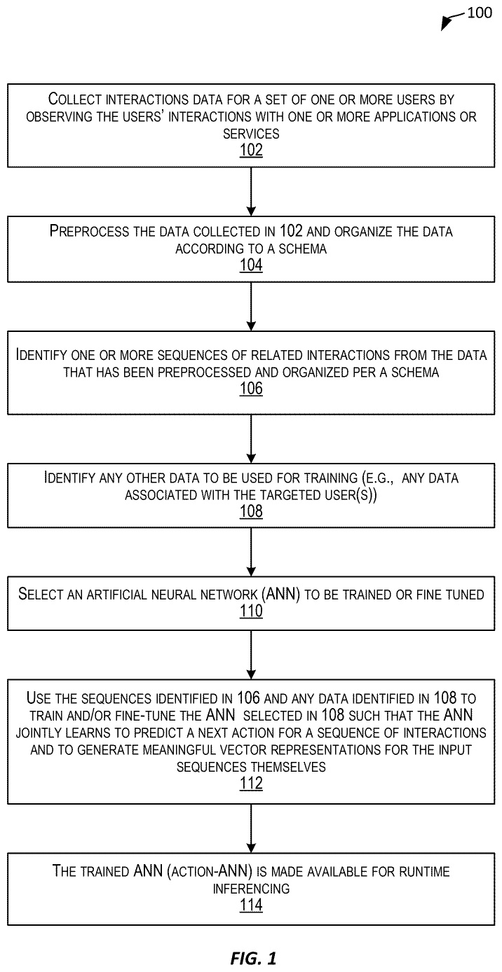

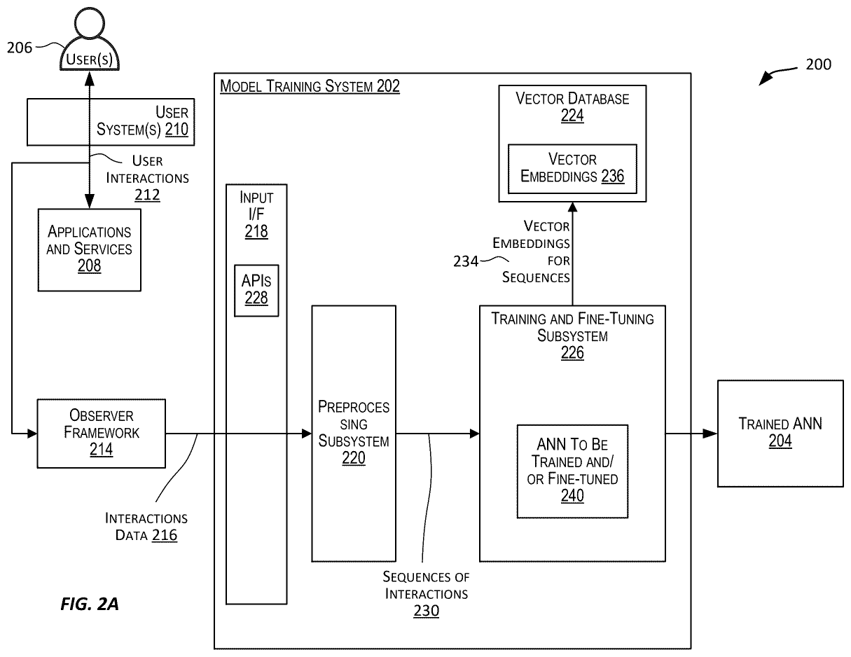

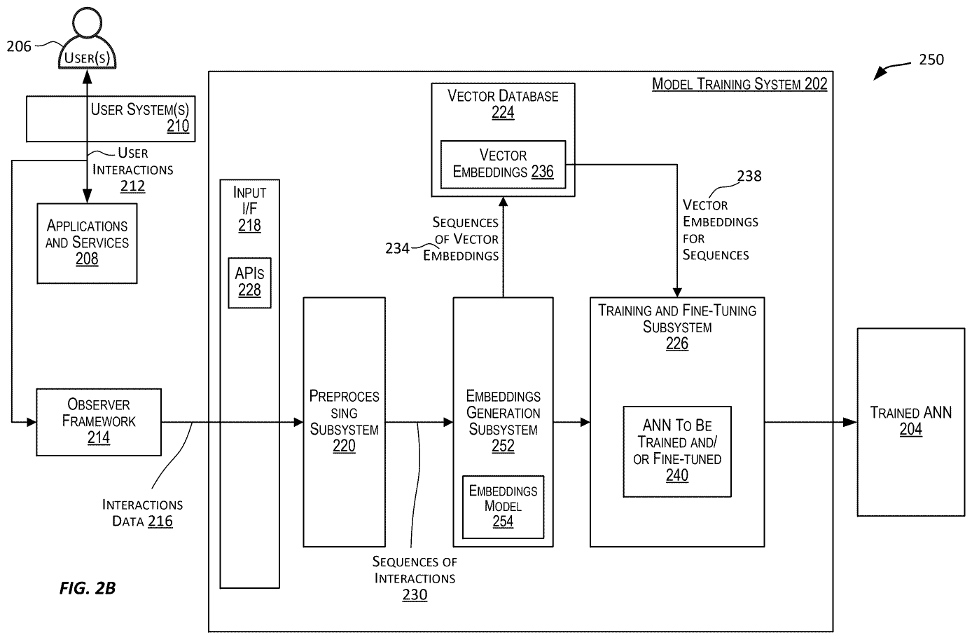

As indicated above, an artificial neural network (ANN) is trained and/or fine-tuned to predict a next action to be performed given a sequence of actions performed by one or more users. The trained ANN can then be used during online inferencing to predict next actions for a set of users based upon the user's interactions with one or more applications or services. FIG. 1 depicts a simplified flowchart 100 depicting processing performed for training an ML model such as an ANN to predict actions according to certain embodiments. In certain embodiments, the processing depicted in FIG. 1 may be performed by the systems and components depicted in FIGS. 2A and 2B.

The processing depicted in the various flowcharts included in this disclosure, including flowchart 100 depicted in FIG. 1, may be implemented in software only (e.g., code, instructions, program) executed by one or more processing units (e.g., processors, cores) of the respective systems, using hardware only, or using a combination of software and hardware. The software may be stored on a non-transitory storage medium (e.g., on a memory device). A method presented in a flowchart is intended to be illustrative and non-limiting. While a particular figure depicting a flowchart, such as FIG. 1 depicting flowchart 100, may depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in a flowchart may include more or a lesser number of steps than those depicted in the flowchart.

At a high level, training data is collected, where the training data includes interactions by one or more users with one or more application or services. The training data is then used to train and/or fine-tune an artificial neural network (ANN, also referred to as a model). Accordingly, at 102, interactions data is collected for one or more users by observing the users'interactions with one or more applications or services. The collected data may include, for each user in the one or more users, data related to interactions that the user made with one or more applications or services. For each interaction, the collected data may include temporal information associated with the interaction identifying a time when the interaction occurred, information identifying an application with which the interaction was performed, and other context information related to the interaction.

The data collected in 102 may be for one user or for multiple users. Examples of multiple users include user in an enterprise or organization, users in a particular group or subdivision of an organization (e.g., members of the legal team, engineers within an organization), a few specifically chosen users, and the like.

For a user for whom data is collected in 102, the user's interactions with various different applications may be observed and interactions data collected based upon the observations. Examples of such applications include applications for opening reading and sending emails (e.g. Microsoft Outlook), browsers (e.g., Apple Safari, Google Chrome, Microsoft Edge), applications for editing documents (e.g., Microsoft WORD), applications for presentations (e.g., Microsoft PowerPoint), applications that enable collaboration such as for creating and managing websites and content (e.g., Microsoft Sharepoint), messaging applications (e.g., Zoom, Slack, Microsoft Teams, Cisco Webex), applications for creating and editing images (e.g., various applications provided by Adobe), spreadsheet applications (e.g., MS Excel), code Integrated Development Environments (IDEs) (e.g., NetBeans, Eclipse, IntelliJ, Visual Studio), and the like. A user can also interact with various services including one or more cloud services offered by a cloud services provider (CSP). In certain use cases, the applications for which the user's interactions are observed may be specifically tagged and the user's permission may be obtained before the observing is initiated.

A user may interact with the applications or services using one or more devices used by the user (referred to as user devices) and their associated input and output components. Examples of input components that the user may use to interact with an application can include a mouse, a keyboard, digital stylus or pencil, touch screen input interfaces, and the like. Examples of user devices include a laptop, a mobile device (e.g., a mobile phone, a tablet), a game console and associated screen, and the like.

An application or service that a user interacts with may be executed by a user system (e.g., on a user's laptop or mobile device), or by a system that is remote from the user system and connected to the user system via a communication network. For example, an application or service may be executed by a server within an enterprise and the application or service may be used by multiple users. As another example, the application or service may be executed by infrastructure (e.g., a data center) provided by a cloud service provider (CSP).

A user's interactions with an application or service can take various forms such as keyboard keystrokes input by the user in a certain areas of an application, mouse clicks input by the user in certain areas of an application, eye gazes of the user viewing certain areas of an application, and others. Various different techniques and tools may be used to record and collect data related to the user's interactions with applications. In certain implementations, an observer framework is provided for observing users interactions and capturing associated interactions data. The observer framework can include one or more agents or tools configured to monitor the users'interactions with one or more applications and services. The agents or tools can be application or service-specific and be embedded in the application or service. For example, for a document editing application (e.g., MS WORD), the agents may be embedded in the application. In some implementations, a productivity software package may be provided as part of the observer framework to collect the interactions data. In other embodiments, the agents or tools may be application or service agnostic and instead may be associated with the user device. Examples of such agents or tools include screen or touchscreen capture tools, mouse and keystroke tracking tools, eye gaze tracking tools to log step-by-step user interactions, etc. Various different techniques may be used by the observer framework to observe and capture the interactions for a user including but not limited to capturing a video of the user's interactions and subsequent analysis of the video to identify specific interactions, using a keystroke logger or capture tool, using an eye gaze tracking tool to collect data about a portion of an application viewed by the user, using mouse input and tracking tools, using a screen scraping tool, a web scraping tool, using screencast/screen recording tools, and the like. In certain use cases, the observer framework may output one or more users interactions logs that include interactions data related to the interactions made by the users with one or more applications or services.

In certain implementations, the interactions for a user may be monitored on a continuous basis over a period of time. Temporal information is captured for each user interaction such that temporally-related sequences of interactions can be determined for a user, where within a sequence, the interactions in the sequence are ordered in a temporal manner with the earliest interaction in time coming before a later interaction. The temporal information may take various forms. In some embodiments, the temporal information associated with an interaction may be a timestamp indicative of when the interaction was performed. For example, the temporal information may identify a time of day, a day of the week, etc. In some other embodiments, the temporal information may be in the form of a rolling sequence number that indicates a temporal order when the interaction was performed relative to other interactions.

It is possible that a user performs multiple tasks concurrently. For example, a user may schedule execution of a certain task and while that task is running, the user may perform some other interaction concurrently. When the scheduled task finishes, its output may then be leveraged by the user in their ongoing interactions (e.g., adding or editing entries in an Excel spreadsheet based on a long running DB query). A user may perform a first sequence of interactions and a second sequence of interactions, where there may be a temporal overlap between the two sequences.

The data collected in 102 may also include context data for each interactions, where the context data for an interaction may be related to the interaction itself, to the application with which the interaction was performed, related to the user performing the interaction, and the like. This context data may be captured by the observer framework. The context data for a user interaction may include, for example, information about the environment (e.g., home, office, away) where the user interaction occurred. The context data may include information related to the device used by the user for the interaction, such as a device type (e.g., phone, laptop, smart watch), an IP address associated with the device, a version of an operating system executed by the device, information identifying the application with which the interaction occurred, etc. The context data may also include “logical” temporal data related to the user such as time of the interaction relative to when the user's session with the user device or application started (e.g., whether the interaction occurred closer to the start of the user's workday, near the end of the workday, how long was the user using the application when the interaction occurred, etc.). The context data may include information indicative of the user's location when the interaction occurred.

The context data may also include data that was involved or affected by the interaction. For example, if a user interaction corresponds to a user opening and reading an e-mail using Outlook, the context data for the interaction may include the contents of the e-mail including information identifying the sender of the e-mail, the subject line of the e-mail, the body of the e-mail, any attachments to the e-mail, and other data related to the e-mail. As another example, if the interaction corresponds to a user performing a search using a browser, the context data for the interaction may include the URL link of the search web page, the search terms entered by the user, and the results of the search. The context data may also provide an environment context for the interaction. For example, for the email use case described below, the time when the email was received, whether received on the weekend or during the weekday, whether the email is marked as “urgent,” and information related to other environment factors may be included in the context data.

At 104, the interactions data collected in 102 is preprocessed and organized according to a schema. Preprocessing can include filtering out data that is not relevant for training purposes. For example, in some use cases, only certain applications or services may be included for the model training, such as only those applications and services that are commonly used by the users. In such a use case, as part of the preprocessing, data related to an application or service that is not included may be filtered out. Preprocessing can also include cleaning out the data to ensure privacy and confidentiality of the collected data. This cleaning out may include, for example, removing any personal identification information (PII) from the collected data. Preprocessing can include other data modifications and processing such as processing that is performed on the collected interactions data to prepare the data for training or fine tuning purposes.

In certain implementations, as part of the processing performed in 104, after the preprocessed data is then organized according to a schema. In certain implementations, for each user interaction (also referred to as user action), the data for the interaction is organized according to a schema. An example of such a schema is shown below:
Schema: <Temporal Data, Interaction, Application Identifier, Context Data, Environment>

### Where:

Temporal Data—indicates the time information associated with that interaction such that when the user interaction was performed relative to other user interactions can be determined.
Interaction—Information identifying the nature of the specific user interaction.
Application Identifier—Identifies the specific application with which the user interaction was performed.
Context Data (also referred to as content data)—Includes any contextual data associated with the interaction. This context data may be interaction-specific, application or service specific, specific to the user making the interaction, and the like. Examples of various pieces of data that can be included in the context data have been provided throughout this disclosure.
Environment—Includes data indicative of the environment (e.g., home, office, away) where the user interaction occurred, information related to the device used by the user for the interaction, such as a device type (e.g., phone, laptop, smart watch), an IP address associated with the device, a version of operating system executed by the device, information identifying the application with which the interaction occurred, etc. In some implementations, the environment data may be included in the context data. The user's environment of location may be indicated as GPS coordinates, or as a location category (e.g., home, office, other). By including the environment information, the ANN's output predicting a next action is a function of both the task specific input as well as the environment. The awareness of the environment greatly increases both the diversity of experiences that the ANN is exposed to and the ANN's ability to adapt to new situations in different environments.
In the schema example shown above, some of the components of the schema (e.g., Environment) may be optional.

The following example show an example sequence of user interactions to illustrate how the data may be organized for each interaction using the example schema shown above.

Interaction #1: A user uses a mouse to open Outlook.

### <T1, Mouse Click, Outlook, {Open Outlook}, {Environment: Macbook Pro, Office}>

Interaction #2: The user opens a particular email in Outlook.
to read an email sent to the user by a sender.
<T2, Mouse Click, Outlook, {Email subject line “REST API ques on pagination”, sender: abc@company.com, . . . }, {Environment}>
Interaction #3: The user scrolls the opened email to read the email contents.
<T3, Scroll Down, Outlook, {emails content (including subject line: “REST API question on pagination”, body content, . . . }, {Environment}}, >
Interaction #4: The user opens a Safari browser
<t4, Click, Safari, {open Safari} {environment}>
Interaction #5: The user performs a Google search using the Safari browser with search terms “REST pagination”
<T5, Click “Search”, Safari, {Google Search “REST pagination”}, {Environment}>
Interaction #6: The user reviews the returned search results by scrolling the browser window displaying the search results to identify a section of the results that is most relevant to the user
<T6, Scroll Down, Safari, {<URL>“#pagination details” (search results)”, “section”}, {Environment}>
Interaction #7: The user selects a portion of the search results from the relevant section displayed in Safari
<T7, Select “text”, Safari, {<URL>“#pagination details”, selected text}, {Environment}>
Interaction #8: The user copies the text portion selected in Safari
<T8, Click “Copy”, Safari, {<URL>“#pagination details”, copied text}, {Environment}>
Interaction #9: The user may then select “reply all” for the received email
<T9, Click “Reply All”, Outlook, {email contents (including subject line: “API question on pagination”, <recipients>, . . . }, {Environment}>
Interaction #10: The user pastes the copied text into the reply all email
<T10, Click “Paste”, Outlook, {emails content (including subject line: “API question on pagination”, pasted text, . . . }, {Environment}>
Interaction #11: The user edits the reply-all email and the pasted text
<T11, Edit email body, Outlook, {edits made by user including response by user}, {Environment}>
Interaction #12: The user send the reply-all email
<T12, Click “Send”, Outlook, {contents of sent email, recipients, . . . }, {Environment}>
Interaction #13: The user quits Outlook by selecting the “Close” button

### <T13, Click “Close”, Outlook, {}, {Environment}>

Returning to FIG. 1, at 106, one or more sequences of related interactions are identified from the interactions data that has been preprocessed and organized according to a schema. A sequence of interactions can include a single interaction or multiple interactions that are semantically or logically related and are ordered based upon their associated temporal data. The interactions in a sequence can be from one or multiple applications or services. For each user, one or multiple sequences of interactions may be identified. The one or more sequences identified in 106 and the data associated with the interactions in the sequences represent the training data that is used to train and/or fine-tune an ANN. One or more of the sequences identified for a user may be overlapping temporally, i.e., two separate sequences may have one or more interactions that are performed concurrently.

As indicated above, each sequence of interactions includes interactions that are semantically related. Various different techniques may be used to identify semantically related interactions. In certain implementations, two interactions may be identified as semantically related if the two interactions are performed close in time (the threshold for how close may be configurable) to each other by the same user and there is some context data overlap between the two interactions. A threshold for how close in time the interactions need to be can be configurable. For example, two interactions performed by the same user may be identified as related to each other if they are performed close in time to each other, there is a connection linking the two interactions (e.g., text copied from one application is pasted into another application), and the interactions are considered to be part of the same high level task or workflow performed by the user. In certain implementations, chains of such semantically related interactions may be determined and each chain may represent a sequence of interactions. For example, a first interaction may be determined to be semantically related to a second interaction, the second interaction may be determined to be semantically related to a third interaction, and the third interaction may be determined to be semantically related to a fourth interaction. A chain may be formed involving these four interactions, and the four interactions may represent a sequence of interactions. In this manner, multiple chains of interactions may be determined, each chain representing a sequence of interactions.

For the interactions example discussed above, a sequence of interactions may be identified that includes the thirteen interactions since the interactions are performed by the same user, are performed close in time, and represent a logical task: user opens Outlook, open a particular emails, reads the email, open Safari, performs a Google search in Safari for certain terms from the subject line of the email, reviews search results, opens a reply email, copies a certain portion of the search results to the body of the reply email, makes edits to the reply email, sends the reply email using “Reply All,” and finally closes Outlook. In addition to the interactions being performed close in time and by the same user, based upon the context data associated with the interactions, and assuming T1<T2, <T3<T4<T5<T6<T7<T8<T9<T10<T11<T12<T13, a chain of interactions may be formed based upon the following:
Interaction #2 is identified as semantically related to Interaction #1 because, in Interaction #2, the user opens a particular email from the Outlook instance opened by Interaction #1.
Interaction #3 is identified as semantically related to Interaction #2 because, in Interaction #3, the user scrolls the email opened by Interaction #2.
Interaction #4 is identified as semantically related to Interaction #3 because the two interactions are performed on the same user device, by the same user, and close in time.
Interaction #5 is identified as semantically related to Interactions #3 and #4 because, in Interaction #5, the user performs a search using the browser opened by Interaction #4 and uses search terms from the subject of the email read in Interaction #3.
Interaction #6 is identified as semantically related to Interaction #5 because, in Interaction #6, the user scrolls the search results received from performing the search as a result of Interaction #5.
Interaction #7 is identified as semantically related to Interaction #6 because, in Interaction #7, the user selects a text portion from a section of the results identified by the user by Interaction #6.
Interaction #8 is identified as semantically related to Interaction #7 because, in Interaction #8, the user copies the text portion selected by Interaction #7.
Interaction #9 is identified as semantically related to Interactions #1, #2, and #3 because, in Interaction #9, the user uses the Outlook instance opened by Interaction #1, and performs a “Reply All” to the email opened in Interaction #2 and read in Interaction #3.
Interaction #10 is identified as semantically related to Interactions #8 and #9 because, in Interaction #10, the user pastes the text portion copied in Interaction #8 into a reply email opened by Interaction #9.
Interaction #11 is identified as semantically related to Interactions #1, #9, and #10 because, in Interaction #11, the user uses the Outlook instance opened in Interaction #1, to edit the reply email opened in Interaction #9 and the search results portion pasted into the email by Interaction #10.
Interaction #12 is identified as semantically related to Interactions #9 and #11 because, in Interaction #12, the user sends the email opened by Interaction #9 and edited by Interaction #11.
Interaction #13 is identified as semantically related to Interaction #1 because, in Interaction #13, the user closes the Outlook instance opened in Interaction #1.

In the manner shown above, the thirteen interactions are identified as part of the same chain and thus identified as belonging to the same sequence, say S1. So, sequence S1 includes:
Sequence S1 {Interaction #1, Interaction #2, Interaction #3, Interaction #4, Interaction #5, Interaction #6, Interaction #7, Interaction #8, Interaction #9, Interaction #10, Interaction #11, Interaction #12, Interaction #13}
   Within a sequence, the interactions in the sequence are ordered and sorted based upon their temporal data such that earlier occurring interactions are placed higher up in the sequence before later occurring sequences. A sequence can include interactions with one application or services or with multiple different applications and services.

In some embodiments, a graphing tool may be used to identify sequences of interactions. Each interaction may be represented as a node. A link is created between two nodes, when the interactions represented by the nodes are deemed to be semantically related to each other. In this manner, multiple graphs of connected nodes may be built where each graph represents a sequence of interactions. Identification of the sequences in 106 results in semantic splitting and chunking of the preprocessed data into sequences of related interactions.

At 108, any other data that is to be used for the training is identified. This data may include, for example, data associated with a set of one or more users who are the targeted users of the trained ANN. For example, in some use cases, the training may be targeted for a particular individual user. In other use cases, the targeted audience may be a set of multiple users, such as attorneys in the Legal Department of a company. In 108, data related to the targeted set of users may be identified and accessed. This data may include, for a targeted user, data identifying the user's preferences such as the user's risk level tolerance, past actions performed by the user, the user's expectations about the confidence of the predictions, and prediction expectations, user's response to previous predictions made by other ANNs, the level of details or explainability of prediction expected by the user, etc. In certain implementations, this data may be provided in the form of configuration files.

At 110, an ANN is selected for training and/or fine tuning. The ANN selected in 108 may be one that has already been partially trained or a completely untrained ANN may be selected. Examples of ANN include different types of language models (LMs) including large language models (LLMs). A language model can be different types including but not limited to a statistical model, a deep neural network, a recurrent neural network, a long short-term memory (LSTM) neural network, a transformer model with encoder-decode architecture, and the like. In some uses cases, a large language model (LLM) such as ChatGPT provided by OpenAI, and others may be selected in 110. Typically, there are two common training objectives: (1) Masked Language Modeling (MLM)—Training the ANN such that the ANN learns to predict masked words in a sequence, phrases, or sentences; and (2) Next Sentence Prediction (NSP)—Training the ANN such that the ANN learns to determine whether two sentences are likely to follow each other.

As indicated above, in certain implementations, an ANN that has previously been trained may be selected in 110. For example, an ANN that has been previously seeded and trained on some generic human interactions may be selected in 110. The ANN selected in 110 is then further trained and fine-tuned using the sequences of interactions identified in 106 and any data identified in 108.

At 112, the ANN selected in 110 is trained and/or fine-tuned using the sequences identified in 106 and using any data identified in 108, where as a result of the training and/or fine-tuning, the ANN jointly learns to predict a next action to be performed for a sequence of interactions and also learns to generate meaningful vector representations for each of the sequences of interactions identified in 106. Various different training and fine-tuning techniques may be used in 112. Examples include masked language modeling (MLM) training techniques, various fine-tuning techniques for fine tuning large language models (LLMs), and others. In certain implementations, reinforcement training techniques may also be used. Lightweight reward mechanisms based on real-time productivity improvements, e.g., preference of simple over complex tasks, speed of workflow completion, quality of generated output, can be used in a Reinforcement Learning from Human Feedback (RLHF) framework to guide the training of the action-centric language model towards user-centric actions. Combinations of different techniques may also be used to train the model selected in 112.

The training and/or fine-tuning of the ANN in 112 may continue until the trained ANN has achieved a desired level of accuracy. The trained ANN may also be referred to as an action-centric ANN or action-ANN since it is trained to predict actions. The trained ANN can then be used during the inference phase to predict actions for one or more users during runtime processing.

As part of the processing in 112, the ANN learns to generate a sequence of vector embeddings for each sequence of interactions identified in 106. In certain implementations, for a sequence of interactions identified in 106, a sequence of vector embeddings is generated that comprises a vector embedding for each interaction in the sequence of interactions. For a neural net architecture, specialized one or more embedding layers are added in ANN to learn and refine the sequence embeddings. Typically, the embedding layer is the first layer in an LLM. It takes as input a sequence of tokens (words or sub-words) and maps them to high-dimensional numerical vectors (embeddings). At the start of the training, the weights of the embedding layer can either be randomly initialized or some pre-trained embeddings may be used. These embeddings are then passed to subsequent ANN layers, such as transformers or RNNs, which process the sequences and generate the ANN's output. The embeddings are then refined and fine-tuned as training progresses.

A loss function is typically used to train the ANN, which involves adjusting the ANN's parameters (e.g., weights associated with the ANN), including those of the embedding layer. A loss function is a function that is used to determine the difference between the ANN's predicted output and the desired target output. As part of the training, the loss calculated using the loss function is minimized, and the ANN learns to generate embeddings that effectively capture the semantic and syntactic information in the input sequences of interactions.

A vector embedding generated for an interaction encodes various dimensions of the interaction and associated data. For example, a vector embedding generated for an interaction may encode the temporal data associated with the interaction, the identification of the interaction, the application with which the interaction occurred, and the context or content data associated with the interaction. An embedding for an interaction thus encodes the temporal, content, and context dimensions for the interaction as a vector. Vector embeddings can be used to capture similarities between interactions. The sequence of vector embeddings generated in 112 may be stored in a vector database. An example of a database that provides vector search capabilities is Oracle Database 23ai provided by Oracle Corporation.

The vector embeddings generated in 112 along with the associated data (e.g., context data associated with an embedding corresponding to an interaction) may be stored in a vector database. These embeddings are subsequently used during the inference phase when the trained ANN is used to predict actions for the user.

In certain implementations, as part of the training in 112, masked language modeling (MLM) training techniques may be used to train the ANN. MLM is a training method used especially for language models like BERT, where some tokens in the input sequence are masked, and the model learns to predict the masked tokens based on the surrounding context. MLM has the advantage of bidirectional context, allowing the model to consider both past and future tokens when making predictions. This approach is especially useful for tasks like text classification, sentiment analysis, and named entity recognition. An MLM training method may be used to train the model to predict an action to be performed instead of text. In MLM, the model is trained to predict masked tokens within the input sequence. During training, a certain percentage of tokens are randomly masked, and the model is trained to predict the original tokens at those masked positions. The loss is calculated based on the model's predictions and the actual target tokens (the original tokens that were masked).

As indicated above, the ANN is trained in 112 using the sequences of interactions identified in 106 and any data identified in 108. As part of the training, sequences of embeddings are generated for the sequences of interactions. The embeddings for the interactions in a sequence can be considered as tokens. One or more of the interactions in a sequence are masked and the ANN is trained to correctly predict the masked interactions. For example, for the example sequence S1 described above comprising thirteen interactions with time stamps T1 through T13 may be used for training as follows:
The interaction at T1 may be input to the model with the other interactions masked and the model trained to properly predict the action for time T2.
The interactions at T1 and T2 may be input to the model with the other interactions masked and the model trained to properly predict the action for time T3.
The interactions at T1, T2, and T3 may be input to the model with the other interactions masked and the model trained to properly predict the action for time T4.
The interactions at T1, T2, T3, and T4 may be input to the model with the other interactions masked and the model trained to properly predict the action for time T5.
And so on.
   Various different combinations of the interactions may also be used for the training. For example:
From the thirteen interactions, the interaction at T1 may be masked and the other interactions (T2 through T13) may be input to the model and the model trained to properly predict the action for time T1.
From the thirteen interactions, the interaction at T2 may be masked and the interactions at T1, T3 through T13 may be input to the model and the model trained to properly predict the action for time T2.

In a similar manner, other single interactions or even multiple interactions with a sequence may be masked with the other unmasked. In general, one or multiple interactions from the sequence S1 may be masked and the other unmasked interactions provided as input to the model and the model trained to properly predict the masked interactions.

In some use cases, a large language model (LLM) may selected in 110, for example, a version of ChatGPT provided by OpenAI, BERT, and others. In such use cases, fine tuning techniques may be used to fine tune the model. Fine tuning is a way to enhance the performance of a pretrained LLM for specific tasks or domains. In the present context, an LLM is fine tuned to predict an action to be performed given a sequence of one or more prior performed actions. Various different fine-tuning techniques may be used including unsupervised fine-tuning techniques, supervised fine-tuning (SFT) techniques, instruction fine-tuning techniques, and others, which are based upon the structure of the training dataset. Fine-tuning techniques that update the weights of pretrained LLMs may also be used. Examples of such techniques include full fine-tuning techniques, adapter-based fine-tuning techniques, parameter-efficient fine-tuning (PEFT) techniques, and others.

At 114, the trained ANN, generated as a result of the training and/or fine-tuning performed in 112, is made available for runtime inferencing. Further details related to the use of the trained ANN for predicting actions are described below.

A trained ANN may be retrained and/or retuned to improve its performance. For example, with passage of time, as new user interactions data is available for training purposes, the ANN may be retrained using the newly available data. As another example, if a new application or service is added to the list of applications and services being monitored, the ANN may be retrained using interactions data available for the new application or service. As yet another example, if the prediction quality of the trained ANN regresses during runtime inferencing, for example, if it drops below some minimum acceptable threshold, the ANN may be retrained to improve its performance. For example, in certain use cases, the performance of the trained ANN may drop due to conceptual drift resulting from the data being input to the ANN for predictions during runtime inferencing drifting away from the data that was used to train the ANN. The ANN may also be trained on a periodic basis on-demand.

The user interactions data that is used to train the ANN may be stored on the user device, on one or more servers remote from the user device, or in cloud storage. Likewise, the data and information that is generated from the processing depicted in FIG. 1 may be stored on the user device, on one or more servers remote from the user device, or in cloud storage, and made accessible to the training environment.

FIG. 2A is a simplified block diagram of a distributed environment 200 incorporating a system for training a ML model (e.g., an ANN) for use by the PAS according to certain embodiments. Distributed environment 200 may comprise multiple systems communicatively coupled to each other via one or more communication networks. Distributed environment 200 depicted in FIG. 2A is merely an example and is not intended to unduly limit the scope of claimed embodiments. Many variations, alternatives, and modifications are possible. For example, in some implementations, distributed environment 200 may have more or fewer systems or components than those shown in FIG. 2A, may combine two or more systems, or may have a different configuration or arrangement of systems. The systems, subsystems, and other components depicted in FIG. 2A may be implemented in software (e.g., code, instructions, program) executed by one or more processing units (e.g., processors, cores) of the respective systems, using hardware, or combinations thereof. The software may be stored on a non-transitory storage medium (e.g., on a memory device).

As shown, distributed environment 200 includes a model training system (MTS) 202 that is configured to train an ANN for use by a PAS for predicting actions. At a high level, MTS 202 receives training data 216 as input where the training data includes observed interactions of one or more users with one or more applications or services. MTS 202 is configured to use this user interactions data 216 to train an ANN. The training results in the generation of a trained ANN 204. The trained ANN may, for example, be a trained LLM.

As shown in FIG. 2A, one or more users 206 may interact with one or more applications or services 208 using user systems 210. A user 206 may use one or multiple user systems 210 to interact with applications and services 208. As an example, a user interface corresponding to an application or service may be displayed on user system 210, and a user 206 may interact with the application or service by interacting with this user interface using an input device such as a mouse, a keyboard, etc. In certain implementations, a logging mechanism may be provided on user system 210 for logging user interactions and capturing information related to each user interaction such as the nature of the user input, the application or service with which the interaction was made, the context of the interaction, the outcome (e.g., success or failure, notification output, etc.) of the interaction, the UI/UX through which the interaction was made, and the like.

Applications and services 208 may execute on user systems 210 or on other computer systems remote from user systems 210. In some instances, an application or service may be executed by infrastructure provided by a cloud service provider (CSP) such as in a data center provided by the CSP.

An observer framework 214 is provided for observing and capturing data related to the users'interactions 212 with applications and services 208. Observer framework 214 may capture and/or receive data related to user interactions 212. In certain implementations, a comprehensive view is captured for each interaction including information about the nature of the user input, the application or service with which the interaction was made, the context of the interaction, the outcome (e.g., success or failure, notification output, etc.) of the interaction, the UI/UX through which the interaction was made, and the like.

Observer framework 214 may include one or more agents or tools configured to monitor and collect data on interactions 212 made by one or more users 206 with one or more applications or services 208 using one or more user systems 210. Examples of such tools include tools for capturing a video of user interactions and subsequent analysis of the video to identify specific interactions, a keystroke logger or capture tool, an eye gaze tracking tool to collect data about a portion of an application viewed by the user, mouse input tracking tools, a screen/web scraping tool, screencast/screen recording tools, and the others.

Data collected by observer framework 214 related to user interactions 212 may be communicated by observer framework 214 to MTS 202. In certain use cases, the observer framework 214 may communicate the interactions data 216 to MTS 202 in the form of one or more user-application interaction logs. Various different formats may be used for communicating data 216 to MTS 202. In certain implementations, observer framework 214 may store the interactions data 216 to a memory repository from where it can be accessed by MTS 202.

In the embodiment depicted in FIG. 2A, MTS 202 includes several components and subsystems including an input interface subsystem 218, a preprocessing subsystem 220, a vector database 224, and a training and fine-tuning subsystem 226. MTS 202 and its various subsystems and components may be implemented only in software, only in hardware, or using combinations of hardware and software. The software may be in the form of code or computer readable instructions that are stored on a non-transitory computer readable storage medium such as on a memory device.

Input interface subsystem 218 may provide various tools and mechanisms for ingesting data to MTS 202. In certain implementations, input interface subsystem 218 may provide a set of application programming interfaces (APIs) 228 that are callable by entities to provide the interactions data 216 to MTS 202. For example, a source of interactions data 212 (e.g., observer framework 214) may call an API 228 provided by MTS 202 to communicate user interactions data 216 to MTS 202.

The ingested data 216 may be received by preprocessing subsystem 220, which is configured to preprocess the data and identify sequences of related interactions from the interactions data 216, where the identified sequences of interactions represent training data that is used to train the ANN. For example, preprocessing subsystem 220 may perform the processing depicted in 102, 104, and 106 in FIG. 1 and described above. As part of preprocessing, preprocessing subsystem 220 may filter out data that is not to be used for training, remove personal identifiable information (PII) from the received data, organize the data according to a schema, and identify multiple sequences of related interactions from the organized data. As part of identifying these sequences, preprocessing subsystem 220 may perform analysis to identify related interactions and then form sequences of the related interactions. Preprocessing subsystem 220 may output a set of one or more sequences or interactions to training and fine-tuning subsystem 226, which uses the sequences to train and/or fine-tune an ANN 240.

Training and fine-tuning subsystem 226 may select an ANN to be trained (e.g., processing performed in 110 in FIG. 1). As described above with respect to FIG. 1, various different language models may be selected as the base models for the training. Training and fine-tuning subsystem 226 then trains the selected ANN to generate a trained ANN 204 (e.g., processing performed in 112 in FIG. 1), such that, as a result of the training/fine tuning, the ANN jointly learns to predict a next action to be performed for a sequence of interactions and to also generate meaningful sequences of vector embeddings for the input sequences of interactions.

As part of the training, training and fine-tuning subsystem 226 may identify any data to be used for the training. This corresponds to the processing performed in 108 in FIG. 1. For each sequence of interactions, the ANN learns to generate a vector embedding for each interaction in the sequence of interactions. For each interaction in a sequence, the corresponding vector embedding generated for the interaction may encode the temporal data associated with the interaction, the identification of the interaction, the application with which the interaction occurred, and the context or content data associated with the interaction. The sequences of vector embeddings 236 that are generated as part of the training are stored in a vector database 224.

Various different training and/or fine tuning techniques may be used by training subsystem 226 to train selected model 240. As previously described, these training and fine tuning techniques may include various MLM training techniques, reinforcement training techniques, various fine tuning techniques, other training techniques, and combinations of various training and fine tuning techniques. Various hyperparameters may be set and optimized for training subsystem 226 to facilitate the training. As part of the training, weights and other ANN-specific parameters may be updated based upon one or more optimization techniques. Training subsystem 226 may continue the training (e.g., multiple epochs of training) until the trained ANN achieves a certain desired threshold level of accuracy. The output of the training is a trained ANN 204. Trained action-centric language model 204 may then be used in an inferencing phase where the PAS uses the trained ANN to predict next actions to be performed for a set of user interactions.

The trained ANN 204 may be periodically fine-tuned or retrained by MTS 202 to dynamically adapt to changes in users behavior or in response to new user interactions data being available for training. User interactions may be continuously monitored, and the ANN updated on a periodic basis. In this manner, the ANN is continually trained on the latest users interactions. The ANN is thus dynamically updated to reflect the latest user behavior. For example, changes in the pattern of the interactions that were used to train the ML model may trigger a retraining or re-fine-tuning of the ML model (e.g., a change is detected in a pattern of user interactions from user interactions in the training data that was used to train the trained ML model). A change in the pattern may happen, for example, due to a change in the behavior of users. In this manner, changes in user behavior with respect to one or more applications or services are accounted for. The ANN may also be updated for interactions with new applications or services. The ANN is updated and fine-tuned periodically or incrementally. In certain implementations, the ANN be updated and fine-tuned when the error rate resulting from predictions made by the trained ANN exceeds a configurable threshold. For example, as previously indicated, the performance of the trained ANN may drop due to conceptual drift. In certain implementations, the ML model may be retrained or re-fine-tuned after passage of a certain period of time since the trained ML model was previously trained. Periodic retraining and/or fine tuning of the ANN ensures adaptation of the ANN to changes conditions with minimal data and computational resources.

FIG. 2B is a simplified block diagram of a distributed environment 250 incorporating another system for training an ML model (e.g., an ANN) for use by the PAS according to certain embodiments. Distributed environment 250 may comprise multiple systems communicatively coupled to each other via one or more communication networks. Distributed environment 250 depicted in FIG. 2B is merely an example and is not intended to unduly limit the scope of claimed embodiments. Many variations, alternatives, and modifications are possible. For example, in some implementations, distributed environment 250 may have more or fewer systems or components than those shown in FIG. 2B, may combine two or more systems, or may have a different configuration or arrangement of systems. The systems, subsystems, and other components depicted in FIG. 2B may be implemented in software only (e.g., code, instructions, program) executed by one or more processing units (e.g., processors, cores) of the respective systems, using hardware only, or using a combination of software and hardware. The software may be stored on a non-transitory storage medium (e.g., on a memory device).

The embodiment depicted in FIG. 2B is quite similar to the embodiment depicted in FIG. 2A. Subsystems and components that are common to both the embodiments are labeled using the same reference numbers. For these common subsystems and components, please refer to their descriptions provided above in the context of FIG. 2A. The embodiment depicted in FIG. 2B assumes that there already exists a model 254 for generating vector embeddings for the sequence of interactions. An embeddings generation subsystem 252 is provided that receives sequences of interactions 230 from preprocessing subsystem 220 and uses an existing embeddings model 254 to generate sequences of vector embeddings 234 for the sequences of interactions. For each sequence of interactions, the embeddings generation subsystem 252 uses model 254 to generate a vector embedding for each interaction in the sequence of interactions. The embeddings model 254 may be used to convert, for each interaction, data related to the interaction into a vector that encodes various aspects of the interaction. For each interaction in a sequence, the corresponding vector embedding generated for the interaction may encode the temporal data associated with the interaction, the identification of the interaction, the application with which the interaction occurred, and the context or content data associated with the interaction. The sequences of vector embeddings 234 that are generated as part of the training are stored in a vector database 224 as embeddings 236.

These embeddings are provided as inputs 238 to training and fine-tuning subsystem 226, which uses them to train ANN 240. The ANN 240 is trained and/or fine-tuned to predict a next action to be performed for a sequence of interactions in the training data. Training and fine-tuning subsystem 226 may update the weights and other model parameters of ANN 240 based upon optimization techniques used for the training. Training subsystem 226 may continue the training (e.g., multiple epochs of training) until the ANN 240 being trained achieves a certain desired threshold level of accuracy. The output of the training is a trained ANN 204. Trained ANN 204 may then be used by PAS in an inferencing phase to predict next actions for sequence of user interactions with one or more applications or services.

Similar to the embodiment depicted in FIG. 2A, trained ANN 204 may be periodically fine-tuned or trained so that the performance of the ANN remains at a desirable level and the ANN dynamically adapts to changes in user behavior or in response to new user interactions with same or new applications or services.

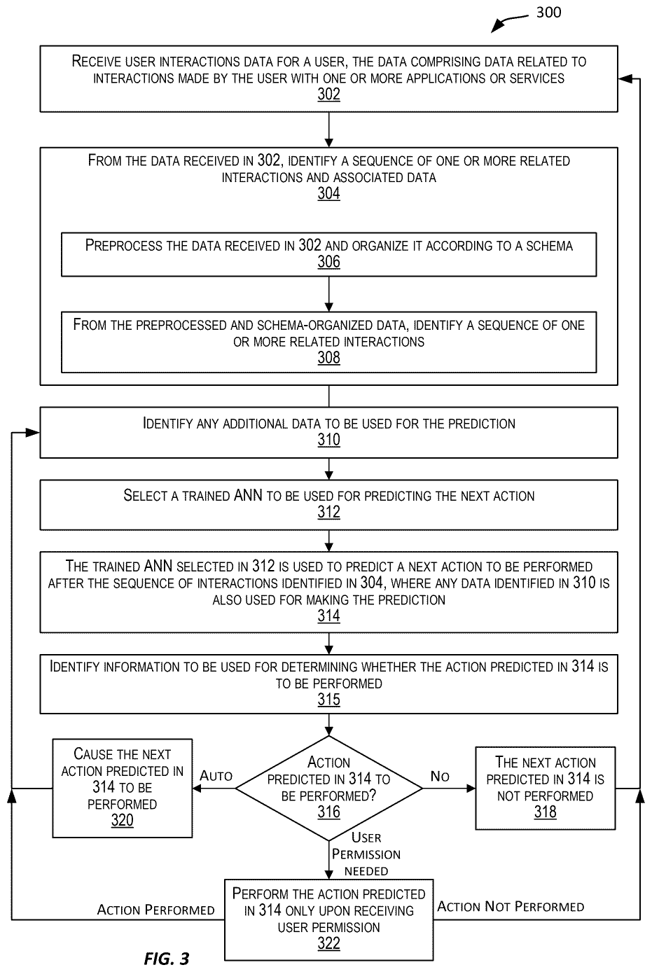

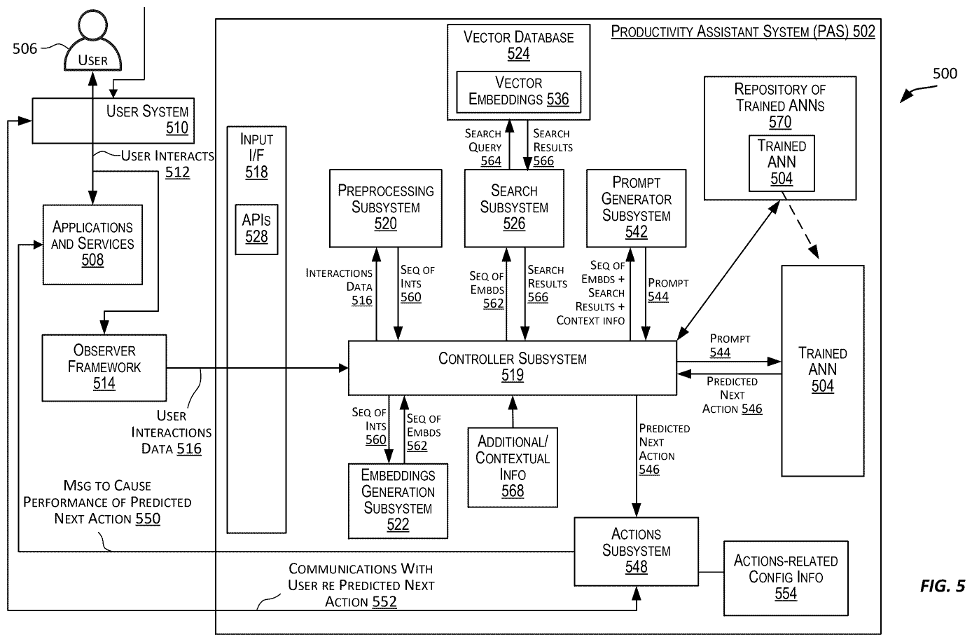

FIG. 3 depicts a simplified high level flowchart 300 depicting processing performed for using a trained ML model (e.g., a trained ANN) for predicting actions for one or more users and for causing one or more of the predicted actions to be performed or executed according to certain embodiments. In certain embodiments, the processing depicted in FIG. 3 may be performed by a PAS that is configured to assist the user with automatically identifying and performing actions predicted using an action-centric language model. An example PAS is depicted in FIG. 5 and described below.

In certain embodiments, the PAS may use the same trained ANN to predict actions for multiple different users. For example, an ANN trained for attorneys in the Legal Department of a company may be used by the PAS to predict actions for those attorneys. In other embodiments, an ANN may have been trained for a particular user and the trained ANN uses this ANN to predict actions for that particular user.

At 302, user interactions data is received or accessed for a user. The interactions data may include data related to multiple interactions made by the user with one or more applications or services. For each interaction, the received data may also include various pieces of information such as temporal information associated with the interaction, information identifying an application with which the interaction was performed, and other context data related to the interaction.

The data received in 302 may have been collected based upon monitoring or observing the user's interactions with various different applications and/or services. Examples of such applications are described above. An application or service that the user interacts with may be executing on a user system, on a system that is remote from the user system and potentially connected to the user system via a communication network, or on infrastructure provided by a cloud service provider (CSP). For example, the application or service may be executed in a data center provided by the cloud service provider.

The user may interact with the applications or services using one or more devices used by the user (referred to as user devices) and their associated input and output components. For example, a user may interact with an application or service using a mouse, a keyboard, digital stylus or pencil, touch screen input interfaces, and the like. Examples of user devices include a laptop, a mobile device (e.g., a mobile phone, a tablet), a game console and associated screen, and the like.

In certain implementations, an observer framework is provided for observing the user interactions and capturing the associated data. As described above, an observer framework can include one or more agents or tools configured to monitor the user's interactions with one or more applications or services. The observer framework may include, for example, a tool for capturing a video of user interactions and subsequent analysis of the video to identify specific interactions, a keystroke logger or capture tool, an eye gaze tracking tool to collect data about a portion of an application viewed by the user, a mouse input or keyboard input tracking tool, a screen/web scraping tool, a screencast/screen recording tool, and the like. In certain use cases, the observer framework stores the interactions related data in user-application logs. In certain embodiments, a user-application log may be provided for each user. In other embodiments, a user-application log may store interactions data for multiple users. The user interactions data may be stored on a user device, on a server, or even on cloud storage in the cloud. The user interactions data may be stored on a user device, on a server, or even on cloud storage in the cloud.

The user interactions may be monitored on a continuous basis over a period of time. Temporal information is captured for each user interaction, such that when a particular user interaction was performed relative to other user interactions can be determined. The temporal information may take various forms. In certain embodiments, a list of applications or services that are to be monitored for a user may be pre-configured. Whenever the user interacts with these applications or services, the user's interactions are monitored and data collected for the interactions.

At 304, a sequence of one or more related user interactions is identified from the interactions data received in 302. Although flowchart 300 depicted in FIG. 3 depicts a single sequence being identified in 304, this is not intended to be limiting and is being done to keep the explanation simple and manageable. In a real use case, multiple sequences of related user interactions may be determined in 304 from the interactions data received in 302, and the processing depicted in FIG. 3 may be performed for each of the identified sequences.

In certain implementations, as part of the processing performed in 304, in 306, the interactions data received or accessed in 302 may be preprocessed and organized according to a schema. The processing performed in 306 may be similar to the processing performed in 104 in FIG. 1. The processing in 306 can include filtering out data that is not relevant, cleaning out the data, for example, to ensure privacy and confidentiality of the collected data. This cleaning out may include, for example, removing any personal identification information (PII) from the data. As part of the preprocessing in 306, the data for the interactions may be organized according to a schema. An example of one such schema is:
Schema: <Temporal Data, Interaction, Application Identifier, Context Data, Environment>
   and is described above. As shown, data indicative of the environment in which the interaction occurs is part of the schema. The awareness of the environment greatly increases both the diversity of experiences that ANNs are exposed to and their ability to adapt to new situations in different environments.

At 308, a sequence of related user interactions is identified from the preprocessed and schema-organized data. The sequence identified in 308 can include one or multiple user interactions with one or multiple applications or services. Within the sequence, the interactions may be ordered based upon their associated temporal data. For example, an interaction with an earlier associated temporal data occurs earlier in the sequence than an interaction with a later temporal data. It is possible for two different interactions to occur at the same time. The interactions in the sequence identified in 304 (or 308) can be from one or multiple applications or services. For example, in the case of multiple applications, the sequence identified in 304 (308) can include one user interaction for a first application, a second interaction for a second application, and so one. As another example, in the case of multiple services, the sequence identified in 304 (308) can include one user interaction for a first service, a second interaction for a second service, and so on. As yet another example, the sequence identified in 304 (308) can include one user interaction with a first service, a second interaction with a first application, a third interaction with a second service, and so on.

As previously described, in certain implementations, two interactions may be identified as related if the two interactions are semantically related, such as when they are performed close in time (the threshold for how close may be configurable) to each other and there is some context data overlap between the two interactions. For example, two interactions may be identified as related to each other if they are part of the same high level task performed by the user. Interactions that are semantically related to each other may thus be identified as part of the same sequence. As previously described for FIG. 1, various different techniques and tools may be used to perform the identification of related sequences in 304 (or 308), such as graphing tools, and others.

At 310, the PAS identifies any additional data to be used for the prediction. This additional data may, for example, include data related to the user for whom the prediction is to be done, such as data identifying the user's preferences (e.g., the user's risk level tolerance, confidence level expectation for a prediction, level of details or explanability of prediction expected by the user), the user's past reaction to predicted actions (e.g., how often the user agreed with the predicted action and allowed the action to be performed, which actions did the user allow to be performed, which actions the user identified as an incorrect prediction), information related to the user (e.g., the skill level of the user, the job title of the user, the user's work experience), and the like. The user's bias towards reviewing a predicted action before the action is performed or performing the predicted action in an automated manner without seeking the user's approval, etc. The additional data may also include information related to a group of which the user is a member (e.g., the Legal group), such as preferences, etc. for the group. In certain embodiments, this information may be stored in configuration files that are accessed by the PAS in 310.

At 312, the PAS selects a previously trained ANN to be used for making the prediction. In certain embodiments, the PAS may have access to multiple trained ANNs, which can include ANNs trained for particular users, ANNs trained for groups of users, ANNs trained for particular applications and services, and the like. As part of 312, the PAS may identify a particular trained ANN that is appropriate for making the prediction based upon the sequence of interactions identified in 304 and associated information. For example, the PAS may perform the selection based upon the identity of the user, groups that the user is a member of, the one or more applications or services identified in the sequence of interactions identified in 304, and other criteria. The PAS may search its database of trained ANNs to identify an appropriate ANN to be used. For example, the PAS may identify a trained ANN that is trained particularly for the user performing the interactions and is particularly trained for the applications or services involved in the sequence of interactions identified in 304. As another example, if the user is a member of a Legal Dept in a company and an ANN has been trained for the Legal Dept, the PAS may select that trained ANN in 312.

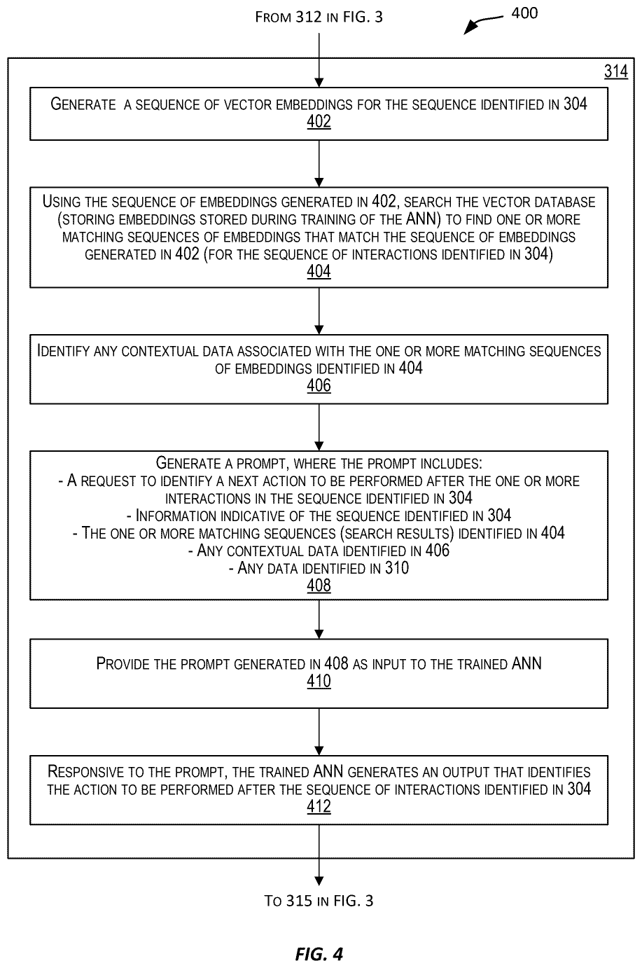

At 314, the PAS uses the trained ANN selected in 312 to predict a next action to be performed after the sequence of interactions identified in 304 and also based upon any data identified in 310. Further details related to the processing performed in 314 is depicted in flowchart 400 depicted in FIG. 4 and described below.

As part of 314, the trained ANN generates an output that identifies a next action predicted by the trained ANN to be performed after the one or more user interactions in the sequence identified in 304. In certain implementations, the prediction generated by the trained AN may include information identifying:
The next action to be performed after the last interaction in the sequence of interactions;
An application in which the action is to be performed; and
Any context data to be used for performing the action.

For example (example modeled on the S1 sequence example), if the sequence identified in 304 is sequence S2 as shown below,

Sequence S2{//start of sequence
Interaction #1: A user uses a mouse to open Outlook.

### <T1, Mouse Click, Outlook, {Open Outlook}, {Environment: Macbook Pro, Office}>

Interaction #2: The user opens a particular email in Outlook.
to read an email sent to the user by a sender.
<T2, Mouse Click, Outlook, {Email subject line “Ques about neural networks”, sender:abc@company.com, . . . }, {Environment}>
Interaction #3: The user scrolls the opened email to read the email contents.
<T3, Scroll Down, Outlook, {emails content (including subject line: “Ques about neural networks”, body content, . . . }, {Environment}},>
Interaction #4: The user opens a Safari browser
<T4, Click, Safari, {Open Safari} {Environment}>}//end of sequence S2
Then, the next action predicted using the trained ANN may be the following action:

### Predicted Next Action:

### <T5, Click “Search”, Safari, {Google Search “Neural Networks”}, {Environment}>

indicating that the next predicted action to be performed is to do a Google search using the Safari browser with search terms “Neural networks.”

In certain embodiments, a single next action may be predicted in 314. In other embodiments, a sequence of multiple actions may be output by the trained ANN in 314.

At 315, the PAS identifies any information to be used for determining whether the action predicted in 314 is to be performed. In certain implementations, one or more of the following pieces of information may be identified in 315:

(1) User preferences information may include—

(a) Permitted actions information—For example, preferences configured for the user (or a group to which the user belongs) may specify: actions that can be performed automatically by the PAS without seeking the user's permission, actions that can only be performed after seeking the user's permission or authorization, and actions that are not be performed by PAS at all.
(b) Risk level or confidence level information—Information may be configured for the user (or for a group to which the user belongs) indicating that a predicted action is to be considered for performance only if the confidence level associated with the predicted action exceeds a certain preset threshold. For example, a user may specify that a predicted action can be performed automatically only when the confidence level associated with the prediction exceeds some user-configurable threshold (say >99%) for some low-risk scenarios.

Though the confidence of an ANN's (e.g., an LLM's) response depends on the specific context and task, some common methods to infer confidence from the ANN's output:

### (A) Internal Model Probabilities:

Fine-grained token-level probabilities: During the generation phase, ANNs assign probabilities to each token and these probabilities can be analyzed to infer model's confidence in specific parts of the response.
Coarse-grained Sequence-level probabilities: Use the overall probability of the generated sequence.

### (B) Meta-Learning:

Training on confidence data: ANN's can be trained on datasets that include both generated text and their confidence scores, to predict its own confidence.
   (C) Prompt Engineering can be used to have the ANN provide more information about its confidence or to generate multiple responses with varying levels of certainty.

(2) Risk levels or risk impact associated with actions—Different actions can have different impacts. For example, an action to open an application has a lower impact than an action to delete data from a database. Actions that can be easily rolled back may have lower associated risks than actions that cannot be rolled back or are difficult to roll back. As another example, an action involving sending an email to a friend has a much lower associated risk than an action involving sending an email to a company executive. As a result, different risk levels may be associated with different actions indicative of the impact of the actions. As part of 315, the PAS may access preconfigured information related to these risk levels.

(3) Permissions associated with actions—In certain implementations, different permissions may be associated with different actions. For example, one of the following permissions may be associated with each action:

(a) Automatic—If automatic permission has been configured for an action, then the PAS may automatically cause the action to be performed without requiring any additional user input.
(b) User Authorization needed—If this permission is configured for an action, then the PAS has to first seek user permission or authorization before the action is performed. The PAS may send a message to the user identifying the predicted action and associated data and request the user for authorization to perform the predicted action. If the user responds with an authorization, then the PAS may cause the predicted action to be performed. If the user does not respond or responds with a negative authorization, then the action is not performed.
(c) Do Not Perform—If this permission has been configured for an action, then the action is not performed.

(3) Information regarding PAS operation modes: In certain implementations, the PAS may be configured to operate in different modes. These modes may be user-configurable. For example, the PAS may be configured to operate in one of the following permissions three modes:

(a) Automatic mode—If this mode, the PAS may automatically cause a predicted action to be performed without requiring any additional user input.
(b) User Authorization needed mode—In this mode, the PAS has to seek user permission or authorization before the action can be performed. The PAS may send a message to the user identifying the predicted action and associated data and request the user for authorization to perform the predicted action. If the user responds with an authorization, then the PAS may cause the predicted action to be performed. If the user does not respond or responds with a negative authorization, then the action is not performed.
(c) Do Not Perform mode—In this mode, the PAS does not perform the predicted action.

Accordingly, in 315, the PAS may identify various pieces of information that affect whether or not and how the predicted action is to be performed. At 316, the PAS decides whether the next action predicted in 314 is to be performed. The decision is based upon the information identified in 315. As described above, the information identified in 315 may identify various different factors that impact whether or not the predicted action is to be performed. If multiple factors are identified, the decision is based upon a combination of the multiple factors. For example, if the confidence level associated with the predicted action is below a threshold specific by the user preferences, PAS may decide not to perform the predicted action even though PAS is operating in “automatic” mode. As another example, if PAS is operating in “do not perform” mode, then a decision is made not to perform the action irrespective of the other factors. Accordingly, as part of the decision making in 315, PAS considers a combination of the multiple factors identified by the information accessed in 315. If the PAS is operating in “automatic” mode, whether or not the predicted action is performed may depend upon various factors. In certain implementations, the decision in 316 may depend upon how the PAS is configured. These factors include how the PAS is configured by the user for performance of the predicted actions, the user's preferences, the confidence score associated with the prediction, the risk level associated with the predicted action, and other factors.

Accordingly, depending upon what is determined in 316, processing may continue with 318, 320, or 322. If the decision in 316 is that the predicted action is not to be performed, then at 318, there is no action taken. If the decision in 316, is to perform the action without requiring any user authorization, then in 320, PAS causes the predicted action to be performed. In certain implementations, the PAS may use APIs provided by the applications to cause the predicted action to be performed. For example, the predicted action is for Application A, then PAS may call an API provided by Application A for the predicted action to cause the predicted action to be performed. In some use cases, an informative message may be communicated to the user identifying the predicted action that will be automatically performed by the PAS. The informative message may also provide user-selectable options that enable the user to stop the action from being performed. If the decision in 316 is to perform the action only upon receiving user approval, then in 322, PAS may perform processing to solicit the requisite user authorization. For example, PAS may output information to the user (e.g., via a popup window displayed on the user device) identifying the predicted action and requesting user authorization. If the user provides input authorizing performance of the action, then the PAS may cause the action to be performed.

In certain implementations, the PAS may log information related to the processing depicted in FIG. 3. For example, information may be logged identifying the inputs received in 302, the sequence identified in 304, any additional data identified in 310, the particular trained ANN selected in 312, the next action predicted in 314, the decision made in 316, whether or not the predicted action was performed, any user authorization provided, etc. This logged information may subsequently be used to further train and/or fine-tune the trained ANN to improve the performance of the ANN.

After an action is performed, that action now represents a new user interaction that follows the sequence of interactions identified in 304 and this gives rise to a new sequence of interactions that includes the sequence of interactions identified in 304 followed by the action performed automatically in 320 or performed after receiving user authorization in 322. The processing depicted in FIG. 3 may then be repeated for this new sequence of interactions to identify the next action to be performed. This is shown by the arrows from 320 and 322 to 310. A new action may be predicted for this new sequence of interactions and the processing may be repeated. In this manner, multiple actions may be predicted and performed.

If an action is not performed as per 318 or because user permission was not received in 322, then processing may continue with 302 where additional user interactions data is received and a new sequence of interactions may be identified in 304 from the received data.

In certain implementations, the trained ANN is trained to predict a single next recommended action to be performed given a sequence of one or more user interactions. In some other implementations, the ANN may be trained to predict one or multiple recommended actions (as a sequence) to be performed. These multiple recommended actions may then be orchestrated as a workflow. For example, an example workflow may include the following sequence of recommended actions: call the web search or an LLM API, summarize the result, call the Word API to update the document, invoke the sendmail function with the updated document as attachment, and query the contacts API to identify the list of recipients.

FIG. 4 depicts a simplified high level flowchart 400 depicting an example of processing that may be performed in 314 in FIG. 3 for using a trained ML model (e.g., an ANN) to predict a next action according to certain embodiments. The processing depicted in FIG. 4 is not intended to be limiting. The processing for 314 in FIG. 3 may be implemented in various different ways. An example system for implementing the process An example PAS for implementing the processing depicted in flowchart 400 is depicted in FIG. 5 and described below.

In the embodiment depicted in FIG. 4, at 402, a sequence of vectors embeddings is generated for the sequence of related user interactions identified in 304. As part of the processing performed in 402, a vector embedding may be generated for each interaction in the sequence and its associated data.

In certain implementations, a model that has been trained to generate embeddings may be used to generate the embeddings in 402. In certain implementations, the trained ANN selected in 312 may itself be used to generate the embeddings in 402. For example, the trained ANN may include an embedding layer that takes as input a sequence of tokens (words or subwords), in this case the sequence of interactions identified in 304, and maps them to high-dimensional numerical vectors (embeddings).

The sequence of vector embeddings generated in 402 includes embeddings for the individual interactions in the sequence identified in 304. The embedding generated for an interaction in the sequence encodes the various dimensions of the interaction and its associated data. For example, a vector embedding generated for an interaction may encode the temporal data associated with the interaction, the identification of the interaction, the application with which the interaction occurred, and the context or content data associated with the interaction.

At 404, the sequence of embeddings generated in 402 is used to search a vector database to identify one or more sequences of embeddings stored by the vector database that match the sequence of embeddings generated in 402. As previously described with respect to FIG. 1, as part of training and/or fine tuning the ANN, sequences of embeddings are generated for the sequences of related interactions that are part of the training data that is used to train the ANN. These embeddings are stored in a vector database. As part of the processing in 404, these stored sequences of embeddings in the vector database are searched to identify any sequences that match the sequence of embeddings generated in 402. In certain implementations, a stored sequence of embeddings is considered to match the sequence of embeddings generated in 402 if there is sufficient similarity or overlap between the embeddings in the two sequences. Further, since an embedding for an interaction encodes multiple dimensions of data related to the interaction, a matching or similarity between two embeddings indicates a similarity across the multiple dimensions. The matching sequence of interactions identified in 404 may be similar, but not necessarily identical, to the sequence of interactions identified in 304. For example, if the sequence of interactions identified includes interactions with an Outlook client, the matching sequence of interactions identified in 404 may be with some other mail client. The vector database is searched to find sequences that closely match the sequence identified in 304.

Various different techniques may be used for determining matches between the sequence of embeddings generated in 402 and the sequences of embeddings stored in the vector database. For example, a confidence metric score (e.g., using Euclidean, cosine, dot product, probability, etc. methods) may be computed to determine relevance or similarity between the embeddings. For example, as part of the processing performed in 404 for identifying matching embeddings from the vector database, a confidence metric score (e.g., Euclidean, cosine, dot product, probability, etc.) may be computed to measure the degree of relevancy of the bindings in the vector database to the sequence of embeddings generated in 402. A sequence may be identified as matching if the score is above some threshold, else it may be identified as not a match.

For example, as described above, during the training of the language model, a sequence of embeddings for the example sequence S1 (described previously) may be generated and stored in the vector database. The sequence of interactions identified in 304 may be the sequence S2, described above. As part of the searching performed in 404, the embeddings generated for the interactions in S2 may be deemed to match some of the embeddings stored in the vector database for S1 . As a result, the sequence of embeddings for S1 may be identified, in 404, as a match for the sequence of embeddings generated in 402 for S2 . The match does not have to be an exact match. A threshold degree of similarity or overlap may be configured. If the match between two embeddings is above the threshold, then the embeddings may be considered to match. The order of the embeddings in a sequence of embeddings may also be considered to determine whether a sequence of embeddings for the sequence of interactions identified in 304 matches a sequence of embeddings stored in the vector database. In certain implementations, the greater the number of matching interactions in a stored sequence and the sequence identified in 304, the greater the degree of match between their corresponding sequence of embeddings.

Various different matching techniques may be used in 404 to find matches. For example, in certain embodiments, approximate nearest neighbor) algorithms may be used for finding similar sequences in vector databases.

At 406, any data associated with the one or more embeddings identified in 404 is identified. In certain implementations, the associated data may be stored along with the embeddings in the vector database. In other implementations, the embeddings stored in the vector database may refer or point to the associated data. These references and pointers and the data pointed to by the references or pointers is stored during the training phase. The associated data may include documents, etc. For example, for the email use case described above, the referenced-to data may include the email that was involved in the interactions used for training the language model.

It is possible that, for the sequence identified in 304, no matching stored sequence is found in the vector database in 404 for the sequence of interactions identified in 304. In this case, the processing in 406 may not be performed.

At 408, a prompt is generated that is to be input to the trained ANN. In certain implementations, the prompt includes the following:
(1) Information identifying the sequence of interactions identified in 304 and any associated data. In certain implementations, the sequence of embeddings generated in 402 for the sequence may be included in the prompt.
(2) A request to identify the next action to be performed given the sequence of interactions identified in 304.
(3) Information related to the search performed in 404 including information identifying any matching sequences of embeddings and associated data identified in 406. In certain implementations, the matching sequences and the associated data may be identified as learning examples. For example, these may be identified as n-shot learning examples, where “n” can be zero (in the situation where no matches were found), one, two, etc. depending upon how many matching sequences of embeddings were identified from performing the search in 404.
(4) Any additional data identified in 310 to be used for the prediction. As describe above, this data may include, for example, data related to the user—for example, data identifying the user's preferences, risk level tolerance, confidence level expectation for a prediction, level of details or explanability of prediction expected by the user, the user's past reaction to predicted actions (e.g., how often the user agreed with the predicted action and allowed the action to be performed, which actions did the user allow to be performed, which actions the user identified as an incorrect prediction), information related to the user's skill level, the user's job title of the user, the user's work experience, and the like. the user's bias towards reviewing an action predicted by the ANN before the action is performed or performing the predicted action in an automated manner without seeking the user's approval, etc.

Various different techniques may be used to generate the prompt in 408. In certain implementations, another trained machine learning model may be used to generate the prompt in 408. This model may be trained using the same training data that is used to train the action-centric language model.

At 410, the prompt generated in 408 is provided as input to the pre-trained action-centric language model. At 412, responsive to the prompt, the trained ANN generates as output that identified the next action to be performed after the sequence of interactions identified in 304. Processing then continues with 315 in FIG. 3.

As described above, an ANN (e.g., an LLM) is trained or fine-tuned to predict actions using sequences of interactions from one or more users. The trained ANN is then used, during runtime of inference time, to predict a next action to be performed after a sequence of interactions performed by the user. The same trained ANN may be used to predict the next action for multiple users, where the next action for a user is based upon a sequence of interactions performed by the user. The user or users for which the trained ANN is used to predict the next action during runtime may be the same as or may be different from the set of users whose interactions are used to train the ANN. For example, an ANN may be trained for a Legal Department within a company based upon interactions of users Alice, Bob, and Carter, who are in the Legal Department. The trained ANN may subsequently be used to predict actions for Alice, or Bob, or Carter. The same trained ANN may also be used to predict actions for another user David, who is also in the Legal Department.

FIG. 5 is a simplified block diagram of a distributed environment 500 incorporating a Productivity Assistant System (PAS) 502 that uses a trained ML model (e.g., a trained ANN) to predict actions to be performed for one or more users and then, if appropriate, causes the predicted actions to be performed according to certain embodiments. Distributed environment 500 may comprise multiple systems communicatively coupled to each other via one or more communication networks. Distributed environment 500 depicted in FIG. 5 is merely an example and is not intended to unduly limit the scope of claimed embodiments. Many variations, alternatives, and modifications are possible. For example, in some implementations, distributed environment 500 may have more or fewer systems or components than those shown in FIG. 5, may combine two or more systems, or may have a different configuration or arrangement of systems. The systems, subsystems, and other components depicted in FIG. 5 may be implemented in software (e.g., code, instructions, program) only executed by one or more processing units (e.g., processors, cores) of the respective systems, using hardware only, or combination or software and hardware. The software may be stored on a non-transitory storage medium (e.g., on a memory device).

As shown, distributed environment 500 includes a Productivity Assistant System (PAS) 502 that is configured to assist a user or a group of users with automatically predicting an action to be performed based upon the user's or users'prior interactions with one or more applications or services. For a predicted action, PAS 502 also performs processing to determine if the predicted action is to be performed, and if so, causes the predicted action to be performed. In this manner, PAS 502 acts as a digital assistant for users—by predicting next actions and also potentially automatically performing the predicted actions, the burden on the users to determine which action to perform and to subsequently perform the action is reduced. This improves the user or users'overall productivity. The PAS acts as a guide that suggests actions to be performed and then, if appropriate, causes the actions to be performed. In certain implementations, PAS 502 uses a trained ANN action-centric language model 504 for predicting the actions, where the ANN is trained of fine-tuned using a set of interactions for one or more users, where the one or more users may be the same as or different from user or user for whom the action is predicted.

As shown in FIG. 5, a user 506 may interact with one or more applications or services 508 using a user system 510. Even though a single user system 510 is depicted in FIG. 5, this is not intended to be limiting. User 506 may use one or multiple user systems 510 to interact with applications and services 508. Even though a single user 506 is depicted in FIG. 5, this is again not intended to be limiting. Multiple users may perform the interactions and actions may be predicted for the multiple users. As an example, a user interface corresponding to an application or service may be displayed on user system 510, and user 506 may interact with the application or service by interacting with this user interface using an input device such as a mouse, a keyboard, etc. In certain implementations, a logging mechanism may be provided on user system 510 for logging user interactions and capturing information related to each user interaction such as the nature of the user input, the application or service with which the interaction was made, the context of the interaction, the outcome (e.g., success or failure, notification output, etc.) of the interaction, the UI/UX through which the interaction was made, and the like.

Applications and services 508 may execute on a user system 510 or on other computer system separate from user system 510. For example, an application or service may be executed on a server that is remote from user system 510 and communicatively coupled to user system 510 via a communication network. In some instances, an application or service may be executed or implemented by infrastructure provided by a cloud service provider (CSP) such as by a data center provided by the CSP.

An observer framework 514 is provided for observing and capturing data related to the user's or users'interactions 512 with applications and services 508. Observer framework 514 may capture and/or receive data related to user interactions 512. In certain implementations, a comprehensive view is captured for each interaction including information about the nature of the user input, the application or service with which the interaction was made, the context of the interaction, the outcome (e.g., success or failure, notification output, etc.) of the interaction, the UI/UX through which the interaction was made, and the like. As previously described, observer framework 514 may include one or more agents or tools configured to monitor user interactions 512. Examples of such tools include tools for capturing a video of user interactions and subsequent analysis of the video to identify specific interactions, a keystroke logger or capture tool, an eye gaze tracking tool to collect data about a portion of an application viewed by the user, mouse input tracking tools, a screen/web scraping tool, screencast/screen recording tools, and the others.

The user interactions 512—related data 516 collected by observer framework 514 is communicated to PAS 502. In certain use cases, the observer framework 514 may communicate the interactions data 516 to PAS 502 in the form of one or more user-application interaction logs. Various different formats may be used for communicating interactions data 516 to PAS 502.

In the embodiment depicted in FIG. 5, PAS 502 includes several components and subsystems including an input interface subsystem 518, a controller subsystem 519, a preprocessing subsystem 520, an embeddings generation subsystem 522, a search subsystem 526 that is coupled with a vector database 524, a prompt generator subsystem 542, and an actions subsystem 548. PAS 502 and its various subsystems and components may be implemented only in software, only in hardware, or using combinations of hardware and software. The software may be in the form of code or computer readable instructions that are stored on a non-transitory computer readable storage medium such as on a memory device.

Input interface subsystem 518 may provide various tools and mechanisms for ingesting interactions data 516 to PAS 502. In certain implementations, input interface subsystem 518 may provide a set of application programming interfaces (APIs) 528 that are callable by various entities to provide the interactions data 516 to PAS 502. For example, observer framework 514 may be configured to collect information about user interactions 512. One or more components of observer framework 514 may call one or more APIs 528 provided by PAS 502 to communicate the collected user interactions data 516 to PAS 502. Other sources of interactions data 516 may also use APIs 528 provided by input interface subsystem 518 to communicate the data to PAS 502.

In the embodiment depicted in FIG. 5, the ingested interactions data 516 is received by controller subsystem 519. Controller subsystem 519 then executes a workflow involving various other subsystems of PAS 502 to process the ingested data, to predict a next action, determine whether the predicted action is to be performed, and if so, cause the predicted action to be performed. In certain embodiments, the workflow may be initiated when controller 519 receives user interactions data 516. Controller 519 may provide the ingested data 516 to preprocessing subsystem 520. Preprocessing subsystem 520 may preprocess the data and, from the preprocessed data, identify a sequence of interactions for which a next action is to be predicted. Processing sub 520 may send a response to controller 519 identifying the sequence of interactions for which a next action is to be predicted. As part of preprocessing the user interactions data, preprocessing subsystem 520 may filter out data that is not relevant, remove personal identifiable information (PII) from the received data, organize the data according to a schema, and identify a sequence of related actions. As part of identifying a sequence, preprocessing subsystem 520 may perform analysis to identify logically related interactions and then determine a sequence of the related interactions. Preprocessing subsystem 520 may output a response 560 to controller subsystem 519 that includes an identified sequence of interactions and associated data. In certain embodiments, the response 560 may identify multiple identified sequences of interactions. In certain implementations, preprocessing subsystem 520 may perform the processing performed in 304, 306, and 308, in FIG. 3, and described above.

Based upon the identified sequence of interactions 560, controller subsystem 519 may identify any additional data to be used for the prediction. Identification of this additional data may include, for example, the processing performed in 310 in FIG. 3, and described above. The additional data may be determined from additional/contextual information 568 accessible to controller subsystem 519. As indicated above for 310, this additional data may include data related to the user, such as data identifying the user's preferences (e.g., the user's risk level tolerance, confidence level expectation for a prediction, level of details or explanability of prediction expected by the user), the user's past reaction to predicted actions (e.g., how often the user agreed with the predicted action and allowed the action to be performed, which actions did the user allow to be performed, which actions the user identified as an incorrect prediction), information related to the user (e.g., the skill level of the user, the job title of the user, the user's work experience), and the like.

Controller subsystem 519 may then provide the sequence of interactions 560 received from preprocessing subsystem 520 to embedding generation subsystem 522 for the next phase of processing. Embeddings generation subsystem 522 is configured to generate a sequence of embeddings for the sequence of interactions 560 provided by the controller subsystem 519 and provide the generated sequence of embeddings 562 as a response to controller subsystem 519. As part of generating the sequence of embeddings 562, embeddings generation subsystem 522 may generate a vector embedding for each interaction in the sequence of interactions. The vector embedding generated for an interaction may encode the temporal data associated with the interaction, the identification of the interaction, the application with which the interaction occurred, the context or content data associated with the interaction, and other data related to the interaction. In certain embodiments, embeddings generation subsystem 522 may perform the processing depicted in 402 in FIG. 4 and described above.

In certain embodiments, embeddings generation subsystem 522 may be implemented as the embedding layer portion of a trained ANN, which may be the first one or more layers of the trained ANN. The embedding layer is trained to take as input a sequence of tokens (words or subwords) (in this case, a sequence of interactions) and map the tokens to high-dimensional numerical vectors (embeddings). In certain embodiments, embeddings generation subsystem 522 may perform the processing depicted in 402 in flowchart 400 depicted in FIG. 4 and described above.

Controller subsystem 519 may then provide the sequence of embeddings 562 received from embeddings generation subsystem 522 to search subsystem 526 for further processing. For a sequence of embeddings received from controller subsystem 519, search subsystem 526 is configured to search the vector embeddings 536 stored in vector database 524 to identify any stored sequence of embedding that matches the sequence of embeddings 562. For example, search subsystem 526 may query 564 the vector database 524 for stored sequences of embeddings that match sequence of embeddings 562. The search results 566 returned by vector database 536 may identify zero, one, or multiples sequences of embeddings from stored vector embeddings 536 that are found to match the sequence of embeddings 526.

The stored vector embeddings 536 represent the embeddings stored during the training of the ANN. As previously described with respect to FIGS. 1 and 2, during the training phase, the ANN learns to generate sequences of embeddings for sequences of interactions identified from the training data that is used to train the ANN. Search subsystem 526 searches these stored sequences of embeddings to identify any sequence of embeddings that matches the sequence of embeddings 562 received from controller subsystem 519.

In certain implementations, a stored sequence of embeddings may be considered to match a sequence of embeddings 562 received by the search subsystem 526 if the similarity or overlap between the sequence of embeddings 562 and a vector embedding stored in vector database 524 is above some user-configurable threshold. Since each embedding for an interaction encodes multiple dimensions of data related to the interaction, a matching embedding is one that is close to the dimensions of the sequence of embeddings 562 across multiple dimensions. As indicated above, the search results 566 may identify zero, one, or multiple matching sequences of embeddings. Search subsystem 542 may provide the search results 566 to controller subsystem 519. In certain embodiments, search subsystem 526 may perform the processing depicted in 404 in flowchart 400 depicted in FIG. 4 and described above.

Controller subsystem 519 may then identify any contextual information associated with any matching sequence of embedding returned by search subsystem 526. The information may be identified from additional/contextual information 568 accessible to controller subsystem 519. This processing may involve the processing depicted in 406 in FIG. 4, and described above.

Controller subsystem 519 may then select a trained ANN 504 to be used for the prediction. The trained ANN 504 may be selected from a repository 570 of trained ANNs accessible to controller subsystem 519. The selection of a particular trained ANN may involve performing the processing depicted in 312 in FIG. 3, and described above. The selection may be based upon different criteria. For example, the selections may be based upon the identity of the user involved in the sequence of interactions identified by preprocessing subsystem 520. The selection may also be based upon any groups that the user is a member of. The selection may additional be based upon the one or more applications or services that are identified in the sequence of interactions.

Processing is then performed to generate a prompt that is input to the selected trained ANN and responsive to which the selected trained ANN predicts a next action to be performed for the sequence of interactions identified by preprocessing subsystem 520. In certain implementations, controller subsystem 519 uses a prompt generation subsystem 542 to generate the prompt. The data provided by controller subsystem 519 to prompt generation subsystem 542 for generation of the prompt may include:
(1) Information identifying the sequence of interactions 560 identified by preprocessing subsystem 520 and any associated data. In certain implementations, the sequence of embeddings 562 generated for the sequence of interactions 560 may be included.
(2) A request to identify the next action to be performed given the identified sequence of interactions 560.
(3) Information identifying any matching sequence of embeddings found by search subsystem 526. Any contextual information related to the found matches. In certain implementations, the matching sequences and the associated data may be identified as learning examples. For example, these may be identified as n-shot learning examples, where “n” can be zero (in the situation where no matches were found), one, two, etc. depending upon how many matching sequences of embeddings were identified by search subsystem 526.
(4) Any additional data identified by controller subsystem 519 to be used for the prediction. For example, this data may include data related to the user—for example, data identifying the user's preferences, risk level tolerance, confidence level expectation for a prediction, level of details or explanability of prediction expected by the user, the user's past reaction to predicted actions (e.g., how often the user agreed with the predicted action and allowed the action to be performed, which actions did the user allow to be performed, which actions the user identified as an incorrect prediction), information related to the user's skill level, the user's job title of the user, the user's work experience, and the like. The user's bias towards reviewing an action predicted by the ANN before the action is performed or performing the predicted action in an automated manner without seeking the user's approval, etc.

Prompt generation subsystem 542 is configured to generate a prompt based upon the various inputs received from controller subsystem 519. The prompt 544 is generated in such a manner that when the prompt is provided to the selected trained ANN, the trained ANN responds by generating an output that identifies a next action to be performed after the interactions in the sequence of interactions. Prompt generation subsystem 542 may use various different techniques to generate the prompt 544. In certain implementations, prompt generation subsystem 542 uses another trained machine learning model to generate the prompt. In certain embodiments, prompt generation subsystem 542 may perform the processing depicted in 408 in FIG. 4, and described above.

Controller subsystem 519 may then input the generated prompt 544 to the selected trained ANN 504. For example, controller subsystem 519 may perform the processing in 410 in FIG. 4. In response, the trained ANN 504 generates an output 546 that identifies a next action to be performed after the sequence of interactions 560. In certain implementations, the output generated by trained ANN 504 comprises:

(1) Information identifying an action to be performed after the sequence of interactions 560.
(2) Information identifying an application in which the next action is to be performed.
(3) Information identifying any context information to be used for performing the predicted next action. For example, if the action to be performed is a Google search using a browser, the context information may identify the search terms to be used for performing the search. As another example, if the action is that a body of an email is to be edited, the context information may identify the edits to be performed. As yet another example, if the action is that an email is to be sent, the context information may identify the one or more recipients of the email. The context information may depend upon the action to be performed and the application to be used for performing the action.

As indicated above, the prompt provided to trained ANN 504 includes search results obtained by search subsystem 526 and also any data associated (e.g., documents, emails, etc.) with the search results. Including these search results and the associated data in the prompt enables trained ANN 504 to use retrieval-augmented generation (RAG) techniques to generate the output. This helps improve the output generated by trained ANN 504 since the trained ANN's capabilities are further augmented and improved by referencing specific examples relevant to the particular sequence of interactions for which a next action is to be predicted. As a result, the trained ANN is able to predict the next action with higher levels of accuracy and context.

The output 546 generated by trained ANN 504 is provided to controller subsystem 519. Processing is then performed to determine whether the predicted next action is to be performed and then causing the predicted next action to be performed, where appropriate. This processing involves the processing depicted in 315, 316, 318, 320, and 322. In the embodiment depicted in FIG. 5, this processing is performed by controller subsystem 519 in conjunction with actions subsystem 548.

In certain implementations, controller subsystem 519 may provide the output 546 generated by trained ANN 504 to actions subsystem 548, where the output includes information identifying the predicted next action. Actions subsystem 548 may then access information to be used for determining whether the predicted next action is to be performed. This information may be determined from actions-related configuration information 554 accessible to actions subsystem 548. As previously described with respect to 315 in FIG. 3, this information may include: user preferences information (e.g., auto permitted actions, user's risk level or confidence level), risk level information associated with the predicted next action, permissions associated with the predicted action, information about operations modes, and other info. Based upon this, actions subsystem 548 determines one of the following three outcomes for the predicted action: (a) do not perform the predicted next action; (b) perform the predicted next action automatically without soliciting any user feedback or authorization; or (c) perform the predicted next action automatically only upon receiving user permission or authorization.

If (a), the predicted action is not performed. If (b), actions subsystem 548 causes the predicted action to be performed without requiring any additional user input. For example, actions subsystem 548 may identify a particular application or service in which the predicted action is to be performed, and then communicate 550 with the particular application or service to cause the action to be performed. In certain implementations, actions subsystem 548 may invoke one or more APIs (or other mechanisms) provided by the particular application or service to cause the predicted next action to be performed. Action subsystem 548 may also use the application or service-provided APIs to provide context information associated with the action to be performed to the application or service such that the context information is used for performance of the predicted action.

If (c), actions subsystem 548 may send a message 552 to the user identifying the predicted action and associated data and request the user for authorization to perform the predicted action. If the user response indicates that the user has authorized the action to be performed, then actions subsystem 548 causes the predicted action to be performed, for example, using APIs provided by the application or service where the action is to be performed. If the user does not respond or responds with a negative authorization, then the action is not performed.

In certain implementations, when a user is prompted for providing authorization regarding a predicted action to be performed, the user may also provide feedback regarding the prediction. For example, for a particular recommended next action presented to the user, the user may confirm that the predicted action is the correct one. Alternatively, if the predicted action is not correct, the user may provide feedback identifying the correct action that should have instead been predicted. In this manner, the user can provide feedback regarding the predicted action. This feedback is used to fine tune and train the trained ANN used by PAS 502 for making the prediction. The user's preferences information may also be updated with this feedback. In certain use cases, all the predictions actions are presented to the user for seeking the user's authorization and the actions are performed only upon receiving the user's authorization.

In situations where the predicted action is not performed, actions subsystem 548 may cause a message (e.g., email, text message, SMS) to be communicated to the user for informative purposes identifying the predicted action and associated data with an indication that the action was not performed. In some instances, the reason (or reasons) why the action was not performed may also be communicated to the user and logged.

In certain implementations, actions subsystem 548 may interact with other tools in the context of the predicted action. For example, actions subsystem 548 may communicate with a task management application for scheduling and/or performing the predicted actions. As another example, actions subsystem 548 may be configured to create tasks in JIRA, which is a project management and issue tracking tool that helps teams plan, track, release, and support software. Actions subsystem 548 may be configured to, or to work with applications configured to, assign the predicted actions to team members with individual task details, track progress regarding performance of the predicted actions, and coordinate performance of the predicted actions across those responsible for the actions.

In the manner described above, PAS 502 received data related to observed user interactions for one or more users and uses a trained ANN to predict a next action to be performed for a user given a sequence of interactions already performed by the user. PAS 502 then performed processing to determine if a predicted action is to be performed automatically without user authorization, to be performed only upon receiving user authorization, or to be not performed. PAS 502 then causes the predicted action to be performed, as appropriate. The predicted action may be performed temporally close to the prior user interactions or may be scheduled for delayed performance. The PAS is able to predict actions to be performed without receiving any specific user inputs such as prompts or queries. For a next action predicted for a particular sequence of interactions, the predicted next action may be associated with one of the applications or services already identified in the particular sequence or may be for a different application or service not identified in the sequence.

User interactions can be observed and monitored across one or multiple applications or services. The applications or services may be executed on a user devices, on one or more computer systems that are remote from the user device, or in a cloud infrastructure (e.g., a data center) provided by a cloud services provider.

In certain implementations, instead of identifying a sequence of interactions from prior observed user interactions, the user may provide a sequence of interactions and query PAS 502 for a next action to be performed given the user-provided sequence of interactions. For example, the user may form a query, where the query includes a sequence of interactions specified by the user and requests PAS 502 to predict and perform a next action. For this use case, the user-specified sequence is used as the sequence for which a next action is to be predicted. Processing is performed, as described above, for the user-specified sequence and PAS output a predicted next action.

The PAS may have access to one or more trained ANNs that are used to predict actions. In some use cases, actions may be predicted for a particular user using a trained ANN that is trained specifically for that particular user. In other use cases, an ANN may be trained for a group of multiple users and the same trained ANN may be used to predict actions for any user in that particular group. The users in the group may share some common characteristics. For example, a group may be defined based upon the users'affiliation with a particular entity, such as users belonging to a particular department (e.g., Marketing dept, Engineering dept), a particular organization (e.g., a particular company, a school, a government organization), and the like. A trained action-centric language model can then be used to predict next actions to be performed for the users or members in that group.

In certain embodiments, each user may be identified using a unique user identifier. Likewise, groups may be identified using unique group identifiers. Information identifying these identifiers may be included in the schema that is used to organize the user interactions data. In this manner, information identifying a user or a group is available for each interaction.

Different trained ANNs may be provided for different applications or services, or groups of applications and/or services. For example, in one use case, application or service-specific trained ANNs may be provided, where a trained ANN predicts actions for a specific application or service for which the ANN is trained. As another use case, an ANN may be trained for multiple applications or services. In this use case, the same trained ANN may be used to predict actions for multiple different applications or services, or combinations thereof.

As described above, an ANN is trained using training data that includes user interactions data for a first set of one or more users. The trained ANN is then used during runtime or inference time to predict actions for a second set of one or more users. The second set of users may be the same as the first set of users or may be different from the first set of users. For example, the ANN may be used to predict an action for a particular user in the second set of users, where the particular user may or may not be part of the first set of users. The user or users for which the trained ANN is used to predict the next action during runtime may be the same as or may be different from the set of users whose interactions are used to train the ANN. In the example provided above, an ANN may be trained for a Legal Department within a company based upon interactions of users Alice, Bob, and Carter, who are in the Legal Department. The trained ANN may subsequently be used to predict actions for Alice, or Bob, or Carter. The same trained ANN may also be used to predict actions for another user David, who is also in the Legal Department.

The trained ANN is dynamically updated over time by training or fine-tuning the ANN as additional users interaction data is available from continuously observing real-world users interactions with applications or services. The ANN is also fine-tuned based upon feedback provided by users of the PAS for whom predictions are made. This helps improve the performance of the ANN and the PAS as a whole, thereby further improving the users'productivity. This saves significant time and energy for a user leading to significant increases in task efficiency, and productivity gains for users while reducing manual effort on the users'part.

The following describes examples of some real-world applications of a PAS. These example are merely examples and are not intended to reduce the scope of claimed embodiments. These examples are not intended to be exhaustive. The teachings described in this disclosure can be used for several other use cases.

(1) Personalized User Research Assistant (Digital Clone)—

(a) The sequence of interactions provided to the PAS can include a list of actions e.g., a team strategy document based on previous conversations and meeting notes with the team members, a review of Pull requests assigned to the user with comments. The PAS may then be used to recommend next actions related to auto-generation of a context-aware email in the user's writing style and tone based on the user's past responses, and also suggest relevant attachments (e.g., team strategy document) to the emails.
(b) As another example, the PAS may auto infer key takeaways, decisions, and action items from meetings, assign tasks to attendees based on their roles and skillset. All this is enabled by training the ANN using prior user interactions related to these tasks and actions.

(2) Smart Architecture Design, Software Development and Debugging: The PAS may auto-generate service architecture designs (e.g., chip or cloud service technical design), code snippets and suggest algorithms, and identify and fix code errors and bugs. The input to the PAS may be a prior interactions of users with applications or services used for architecture design, software development and debugging (e.g., architecture design done using Visio, draw.io, etc.; coding session in an IDE like Visual Studio; debugging in pdb debugger; etc.). For example, the ANN may be trained using interactions of a model set of users or experts within an organization. The trained ANN can then be used by PAS to predict actions for other users (i.e., non-expert users) within the organization. In this manner, the interactions and experiences of one set of users is used to teach actions to be performed for a different set of users. For example, the PAS may predict and cause actions to be performed that generate images (e.g., slide decks) or videos (e.g., simulations), where the trained ANN used by the PAS for predicting these actions is trained using interactions observed for an expert set of users.

(3) Smart Workflows: The PAS may automatically gather the details of an incident from different dashboards visited by the user during prior live site issues, identify impact, and inform customers. The PAS may also synthesize information from diverse sources (e.g., web search, various document database, JIRA) to provide comprehensive summaries tailored to specific research questions, e.g., add compiled information on a topic that the user is searching like compete analysis for external vendors and generate recommendations. All this is enabled by training the ANN used by the PAS using prior user interactions related to these tasks and actions.

In certain implementations, the functionality provided by a PAS can be provided as a cloud service using cloud service infrastructure (e.g., including compute, memory, and networking resources) provided by a cloud services provider. The cloud service can be subscribed to by one or more customers of the CSP and available to users associated with the subscribing customers. In certain implementations, the functionality may be offered to a subscribing customer under a Software-as-a-Service (SaaS) model. In some implementations, an Infrastructure-as-a-Service (IaaS) provider may offer the service as part of its infrastructure offerings.

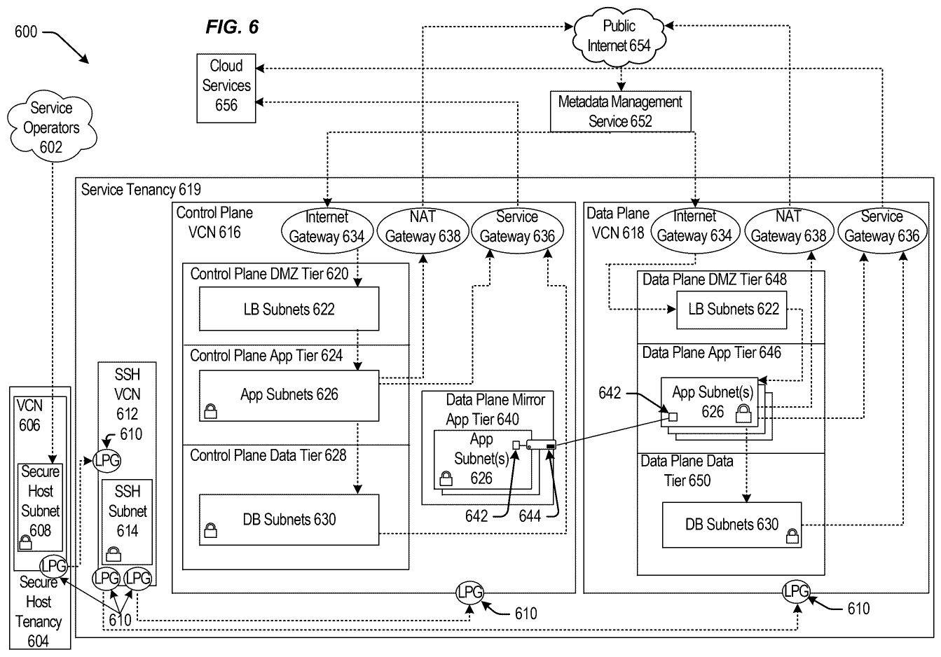

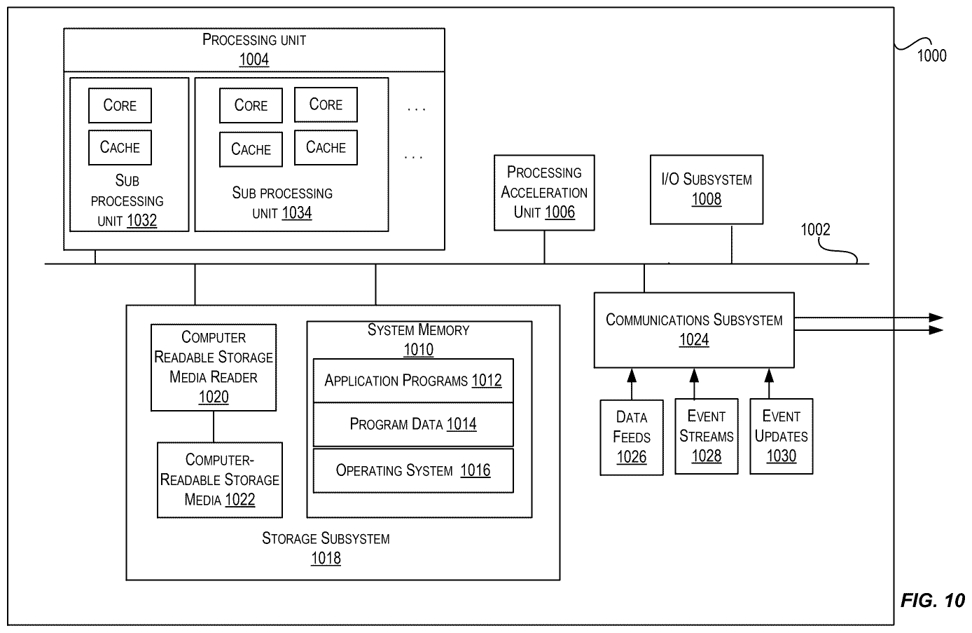

FIGS. 6-9 depict examples of cloud architectures that can be used for implementing and providing one or more cloud services including a cloud service providing the functionality described in this disclosure. FIG. 10 depicts a block diagram illustrating an example computer system or device according to at least one embodiment. One or more multiple of such computer systems may be used to perform processing and provide the functionalities described in this disclosure.

### Example Cloud Infrastructure Architecture Embodiments

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 contained in the SSH VCN 612. The SSH VCN 612 can include an SSH subnet 614, and the SSH VCN 612 can be communicatively coupled to a control plane VCN 616 via the LPG 610 contained in the control plane VCN 616. Also, the SSH VCN 612 can be communicatively coupled to a data plane VCN 618 via an LPG 610. The control plane VCN 616 and the data plane VCN 618 can be contained in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 contained in the control plane DMZ tier 620 can be communicatively coupled to the app subnet(s) 626 contained in the control plane app tier 624 and an Internet gateway 634 that can be contained in the control plane VCN 616, and the app subnet(s) 626 can be communicatively coupled to the DB subnet(s) 630 contained in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 contained in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be contained in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively coupled to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way: the service gateway 636 can make API calls to cloud services 656, and cloud services 656 can send requested data to the service gateway 636. But, cloud services 656 may not initiate API calls to the service gateway 636.

In some examples, the secure host tenancy 604 can be directly connected to the service tenancy 619, which may be otherwise isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision desired resources. Desired resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be contained in the data plane mirror app tier 640 and the data plane app tier 646.

In some examples, users of the system, or customers, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 contained in the control plane DMZ tier 620. The LB subnet(s) 622 may determine that the request is valid, and in response to this determination, the LB subnet(s) 622 can transmit the request to app subnet(s) 626 contained in the control plane app tier 624. If the request is validated and requires a call to public Internet 654, the call to public Internet 654 may be transmitted to the NAT gateway 638 that can make the call to public Internet 654. Metadata that may be desired to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to configuration may be desired to be applied to the resources contained in the data plane VCN 618. Via a VNIC 642, the control plane VCN 616 can directly communicate with, and can thereby execute the changes, updates, or other suitable modifications to configuration to, resources contained in the data plane VCN 618.

In some embodiments, the control plane VCN 616 and the data plane VCN 618 can be contained in the service tenancy 619. In this case, the user, or the customer, of the system may not own or operate either the control plane VCN 616 or the data plane VCN 618. Instead, the IaaS provider may own or operate the control plane VCN 616 and the data plane VCN 618, both of which may be contained in the service tenancy 619. This embodiment can enable isolation of networks that may prevent users or customers from interacting with other users'or other customers'resources. Also, this embodiment may allow users or customers of the system to store databases privately without needing to rely on public Internet 654, which may not have a desired level of threat prevention, for storage.

In other embodiments, the LB subnet(s) 622 contained in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may desire this embodiment since database(s) that the customers use may be controlled by the IaaS provider and may be stored on the service tenancy 619, which may be isolated from public Internet 654.

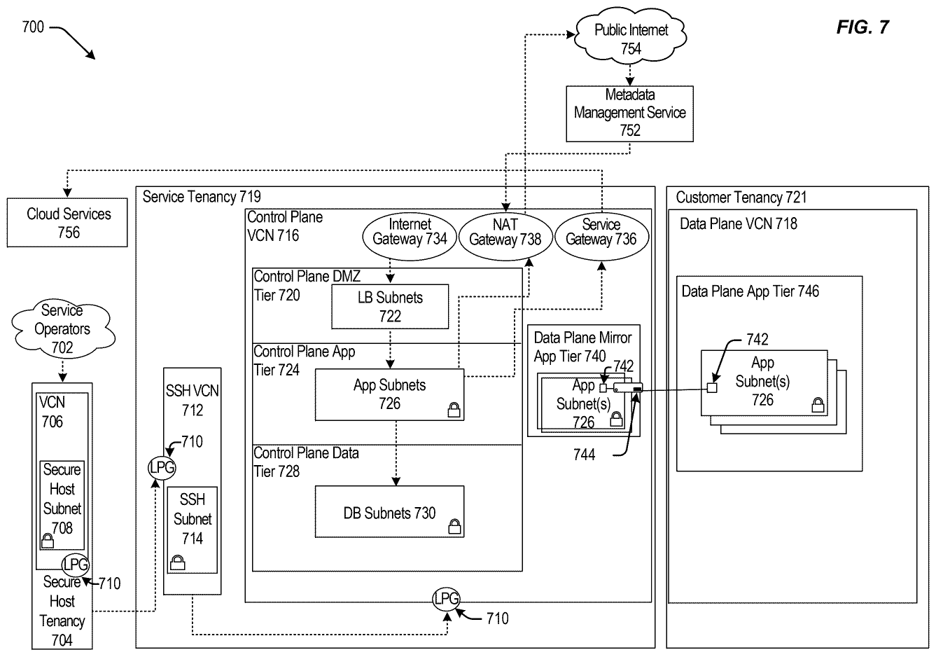

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 610 contained in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 contained in the control plane VCN 716. The control plane VCN 716 can be contained in a service tenancy 719 (e.g., the service tenancy 619 of FIG. 6), and the data plane VCN 718 (e.g., the data plane VCN 618 of FIG. 6) can be contained in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), a control plane data tier 728 (e.g., the control plane data tier 628 of FIG. 6) that can include database (DB) subnet(s) 730 (e.g., similar to DB subnet(s) 630 of FIG. 6). The LB subnet(s) 722 contained in the control plane DMZ tier 720 can be communicatively coupled to the app subnet(s) 726 contained in the control plane app tier 724 and an Internet gateway 734 (e.g., the Internet gateway 634 of FIG. 6) that can be contained in the control plane VCN 716, and the app subnet(s) 726 can be communicatively coupled to the DB subnet(s) 730 contained in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 contained in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be contained in a data plane app tier 746 (e.g., the data plane app tier 646 of FIG. 6) via the VNIC 742 contained in the data plane mirror app tier 740 and the VNIC 742 contained in the data plane app tier 746.

The Internet gateway 734 contained in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 contained in the control plane VCN 716. The service gateway 736 contained in the control plane VCN 716 can be communicatively coupled to cloud services 756 (e.g., cloud services 656 of FIG. 6).

In some examples, the data plane VCN 718 can be contained in the customer tenancy 721. In this case, the IaaS provider may provide the control plane VCN 716 for each customer, and the IaaS provider may, for each customer, set up a unique compute instance 744 that is contained in the service tenancy 719. Each compute instance 744 may allow communication between the control plane VCN 716, contained in the service tenancy 719, and the data plane VCN 718 that is contained in the customer tenancy 721. The compute instance 744 may allow resources, which are provisioned in the control plane VCN 716 that is contained in the service tenancy 719, to be deployed or otherwise used in the data plane VCN 718 that is contained in the customer tenancy 721.

In other examples, the customer of the IaaS provider may have databases that live in the customer tenancy 721. In this example, the control plane VCN 716 can include the data plane mirror app tier 740 that can include app subnet(s) 726. The data plane mirror app tier 740 can reside in the data plane VCN 718, but the data plane mirror app tier 740 may not live in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity contained in the control plane VCN 716. The customer may desire to deploy or otherwise use resources in the data plane VCN 718 that are provisioned in the control plane VCN 716, and the data plane mirror app tier 740 can facilitate the desired deployment, or other usage of resources, of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, contained in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be live or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 5,” may be located in Region 1 and in “Region 2.” If a call to Deployment 5 is made by the service gateway 736 contained in the control plane VCN 716 located in Region 1, the call may be transmitted to Deployment 5 in Region 1. In this example, the control plane VCN 716, or Deployment 5 in Region 1, may not be communicatively coupled to, or otherwise in communication with, Deployment 5 in Region 2.

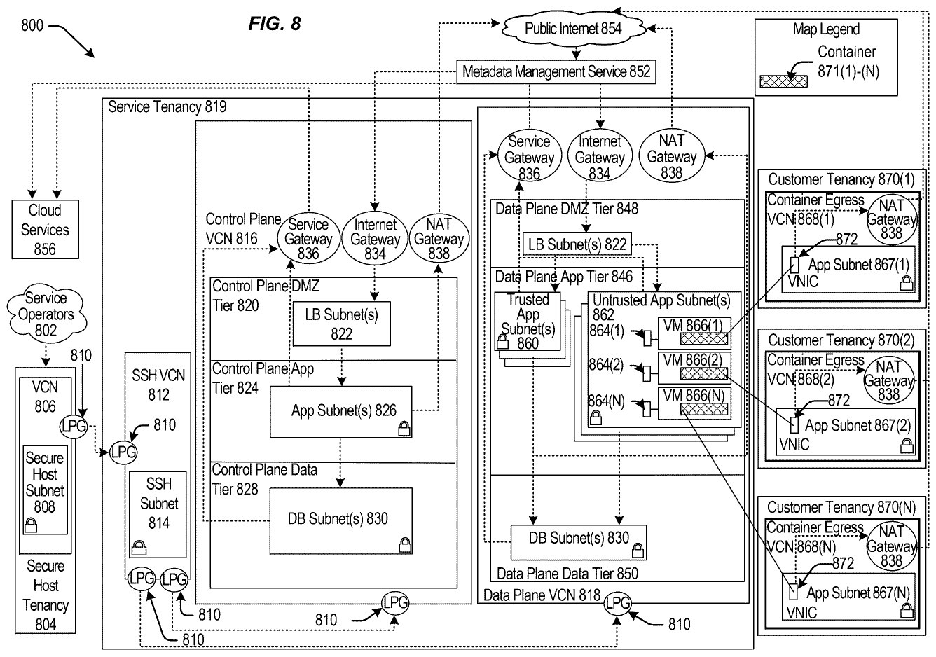

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 contained in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 contained in the control plane VCN 816 and to a data plane VCN 818 (e.g., the data plane 618 of FIG. 6) via an LPG 810 contained in the data plane VCN 818. The control plane VCN 816 and the data plane VCN 818 can be contained in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), a control plane data tier 828 (e.g., the control plane data tier 628 of FIG. 6) that can include DB subnet(s) 830. The LB subnet(s) 822 contained in the control plane DMZ tier 820 can be communicatively coupled to the app subnet(s) 826 contained in the control plane app tier 824 and to an Internet gateway 834 (e.g., the Internet gateway 634 of FIG. 6) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860 and untrusted app subnet(s) 862 of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include one or more primary VNICs 864(1)-(N) that can be communicatively coupled to tenant virtual machines (VMs) 866(1)-(N). Each tenant VM 866(1)-(N) can be communicatively coupled to a respective app subnet 867(1)-(N) that can be contained in respective container egress VCNs 868(1)-(N) that can be contained in respective customer tenancies 870(1)-(N). Respective secondary VNICs 872(1)-(N) can facilitate communication between the untrusted app subnet(s) 862 contained in the data plane VCN 818 and the app subnet contained in the container egress VCNs 868(1)-(N). Each container egress VCNs 868(1)-(N) can include a NAT gateway 838 that can be communicatively coupled to public Internet 854 (e.g., public Internet 654 of FIG. 6).

The Internet gateway 834 contained in the control plane VCN 816 and contained in the data plane VCN 818 can be communicatively coupled to a metadata management service 852 (e.g., the metadata management system 652 of FIG. 6) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some embodiments, the data plane VCN 818 can be integrated with customer tenancies 870. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 846. Code to run the function may be executed in the VMs 866(1)-(N), and the code may not be configured to run anywhere else on the data plane VCN 818. Each VM 866(1)-(N) may be connected to one customer tenancy 870. Respective containers 871(1)-(N) contained in the VMs 866(1)-(N) may be configured to run the code. In this case, there can be a dual isolation (e.g., the containers 871(1)-(N) running code, where the containers 871(1)-(N) may be contained in at least the VM 866(1)-(N) that are contained in the untrusted app subnet(s) 862), which may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completion of running the code, the IaaS provider may kill or otherwise dispose of the containers 871(1)-(N).

In some embodiments, the trusted app subnet(s) 860 may run code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be contained in the VM 866(1)-(N) of each customer and that may run code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

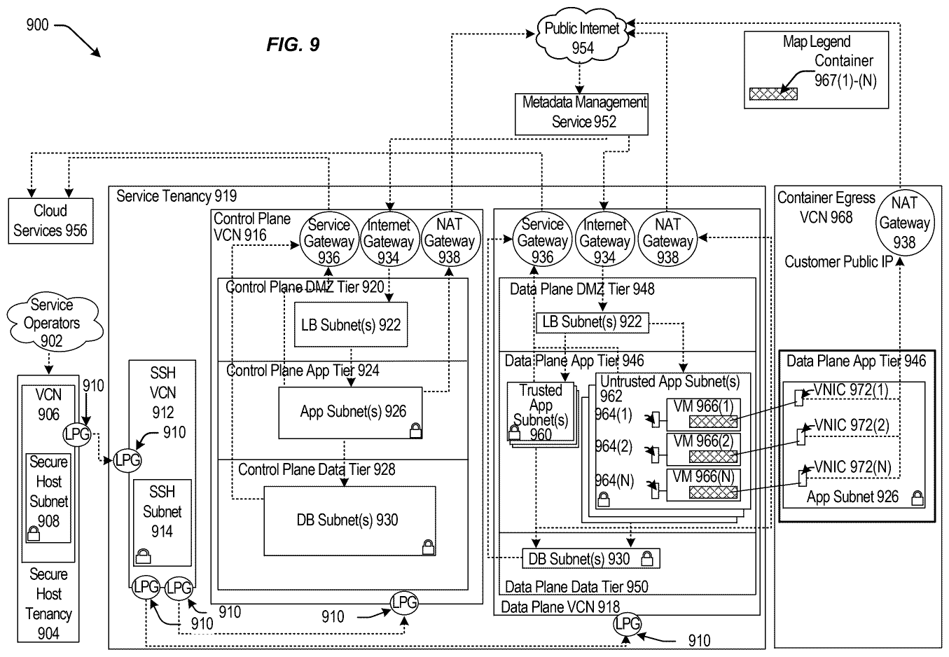

FIG. 9 is a block diagram 900 illustrating another example pattern of an IaaS architecture, according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 contained in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 contained in the control plane VCN 916 and to a data plane VCN 918 (e.g., the data plane 618 of FIG. 6) via an LPG 910 contained in the data plane VCN 918. The control plane VCN 916 and the data plane VCN 918 can be contained in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), a control plane data tier 928 (e.g., the control plane data tier 628 of FIG. 6) that can include DB subnet(s) 930 (e.g., DB subnet(s) 830 of FIG. 8). The LB subnet(s) 922 contained in the control plane DMZ tier 920 can be communicatively coupled to the app subnet(s) 926 contained in the control plane app tier 924 and to an Internet gateway 934 (e.g., the Internet gateway 634 of FIG. 6) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include primary VNICs 964(1)-(N) that can be communicatively coupled to tenant virtual machines (VMs) 966(1)-(N) residing within the untrusted app subnet(s) 962. Each tenant VM 966(1)-(N) can run code in a respective container 967(1)-(N), and be communicatively coupled to an app subnet 926 that can be contained in a data plane app tier 946 that can be contained in a container egress VCN 968. Respective secondary VNICs 972(1)-(N) can facilitate communication between the untrusted app subnet(s) 962 contained in the data plane VCN 918 and the app subnet contained in the container egress VCN 968. The container egress VCN can include a NAT gateway 938 that can be communicatively coupled to public Internet 954 (e.g., public Internet 654 of FIG. 6).

The Internet gateway 934 contained in the control plane VCN 916 and contained in the data plane VCN 918 can be communicatively coupled to a metadata management service 952 (e.g., the metadata management system 652 of FIG. 6) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some examples, the pattern illustrated by the architecture of block diagram 900 of FIG. 9 may be considered an exception to the pattern illustrated by the architecture of block diagram 800 of FIG. 8 and may be desirable for a customer of the IaaS provider if the IaaS provider cannot directly communicate with the customer (e.g., a disconnected region). The respective containers 967(1)-(N) that are contained in the VMs 966(1)-(N) for each customer can be accessed in real-time by the customer. The containers 967(1)-(N) may be configured to make calls to respective secondary VNICs 972(1)-(N) contained in app subnet(s) 926 of the data plane app tier 946 that can be contained in the container egress VCN 968. The secondary VNICs 972(1)-(N) can transmit the calls to the NAT gateway 938 that may transmit the calls to public Internet 954. In this example, the containers 967(1)-(N) that can be accessed in real-time by the customer can be isolated from the control plane VCN 916 and can be isolated from other entities contained in the data plane VCN 918. The containers 967(1)-(N) may also be isolated from resources from other customers.

In other examples, the customer can use the containers 967(1)-(N) to call cloud services 956. In this example, the customer may run code in the containers 967(1)-(N) that requests a service from cloud services 956. The containers 967(1)-(N) can transmit this request to the secondary VNICs 972(1)-(N) that can transmit the request to the NAT gateway that can transmit the request to public Internet 954. Public Internet 954 can transmit the request to LB subnet(s) 922 contained in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, 900 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

FIG. 10 illustrates an example computer system 1000, in which various embodiments may be implemented. The system 1000 may be used to implement any of the computer systems described above. As shown in the figure, computer system 1000 includes a processing unit 1004 that communicates with a number of peripheral subsystems via a bus subsystem 1002. These peripheral subsystems may include a processing acceleration unit 1006, an I/O subsystem 1008, a storage subsystem 1018 and a communications subsystem 1024. Storage subsystem 1018 includes tangible computer-readable storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative embodiments of the bus subsystem may utilize multiple buses. Bus subsystem 1002 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1004, which can be implemented as one or more integrated circuits (e.g., a conventional microprocessor or microcontroller), controls the operation of computer system 1000. One or more processors may be included in processing unit 1004. These processors may include single core or multicore processors. In certain embodiments, processing unit 1004 may be implemented as one or more independent processing units 1032 and/or 1034 with single or multicore processors included in each processing unit. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, some or all of the program code to be executed can be resident in processor(s) 1004 and/or in storage subsystem 1018. Through suitable programming, processor(s) 1004 can provide various functionalities described above. Computer system 1000 may additionally include a processing acceleration unit 1006, which can include a digital signal processor (DSP), a special-purpose processor, and/or the like.

I/O subsystem 1008 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox®360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments, and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1000 to a user or other computer. For example, user interface output devices may include, without limitation, a variety of display devices that visually convey text, graphics, and audio/video information such as monitors, printers, speakers, headphones, automotive navigation systems, plotters, voice output devices, and modems.

Computer system 1000 may comprise a storage subsystem 1018 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1004 provide the functionality described above. Storage subsystem 1018 may also provide a repository for storing data used in accordance with the present disclosure.

As depicted in the example in FIG. 10, storage subsystem 1018 can include various components including a system memory 1010, computer-readable storage media 1022, and a computer readable storage media reader 1020. System memory 1010 may store program instructions that are loadable and executable by processing unit 1004. System memory 1010 may also store data that is used during the execution of the instructions and/or data that is generated during the execution of the program instructions. Various different kinds of programs may be loaded into system memory 1010 including but not limited to client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1010 may include a basic input/output system (BIOS) containing basic routines that help to transfer information between elements within computer system 1000, such as during start-up.

Computer-readable storage media 1022 may represent remote, local, fixed, and/or removable storage devices plus storage media for temporarily and/or more permanently containing, storing, computer-readable information for use by computer system 1000 including instructions executable by processing unit 1004 of computer system 1000.

Computer-readable storage media 1022 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1000.

Machine-readable instructions executable by one or more processors or cores of processing unit 1004 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments communications subsystem 1024 can include radio frequency (RF) transceiver components for accessing wireless voice and/or data networks (e.g., using cellular telephone technology, advanced data network technology, such as 3G, 4G, 5G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1024 may also be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations of software and hardware. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments, and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving, by a productivity assistant system (PAS), interactions data for a first set of one or more users, the interactions data identifying interactions made by the first set of one or more users with one or more applications or services;
identifying, by the PAS, a sequence of interactions from the interactions data, the sequence of interactions comprising a temporally-ordered set of one or more related interactions;
using, by the PAS, a trained machine learning (ML) model to generate an output that identifies an action to be performed after the one or more interactions in the sequence of interactions, wherein the trained ML model is trained using interactions made by a second set of users with the one or more applications or services; and
causing, by the PAS, the action to be performed, wherein the action is performed in a particular application or particular service from the one or more applications or services.

2. The method of claim 1 wherein the first set of users is different from the second set of users and the sequence of interactions is for a user not included in the second set of users.

3. The method of claim 1 wherein the output generated by PAS using the trained ML model identifies the particular application or the particular service.

4. The method of claim 1 further comprising:
identifying, by the PAS, a second sequence of interactions comprising the one or more interactions in the sequence of interactions identified from the interactions data followed by the action that is performed; and
using, by the PAS, the trained machine learning (ML) model to generate a new output that identifies a new action to be performed based the interactions in the second sequence of interactions.

5. The method of claim 1 wherein the trained ML model is a trained artificial neural network.

6. The method of claim 1 wherein using the trained ML model to generate the output comprises:
generating a prompt comprising
the sequence of interactions, and
a request to identify a next action to be performed after the sequence of interactions; and
providing the prompt as input to the trained ML model; and
responsive to the prompt, predicting, by the trained ML model, the action to be performed after the one or more interactions in the sequence of interactions.

7. The method of claim 6 wherein using the trained ML model to generate the output further comprises:
generating a sequence of vector embeddings for the sequence of interactions, the sequence of vector embeddings comprising a vector embedding for each is in the sequence of interactions; and
identifying, a stored set of sequences of vector embeddings, a matching sequence of vector embeddings that matches the sequence of embeddings generated for the sequence of interactions, wherein the stored set of sequences of vector embeddings correspond to sequences of interactions used for training a ML model to generate the trained ML model; and
wherein the matching sequence of vector embeddings is included in the prompt.

8. The method of claim 6 wherein the prompt further includes information identifying preferences related to one or more users from the first set of users, wherein the preferences affect the output generated by the PAS using the trained ML model.

9. The method of claim 1 wherein receiving the interactions data for the first set of one or more users comprises:
receiving the interactions data from an observer framework, wherein the observer framework observes and collects data related to interactions made by first set of users with the one or more applications or services.

10. The method of claim 9 wherein the observer framework comprises at least one of a tool for recording keystrokes input by the first set of users, a tool for recording mouse clicks input by the first set of users, a tool for capturing eye gazes of the first set of users, a screen scraping tool, a web scraping tool, a screen recording tool, or a tool for capturing a video of the interactions made by the first set of users with the one or more applications.

11. The method of claim 1 wherein the sequence of interactions includes a first interaction made with a first application or service in the one or more applications or services and a second interaction made with a second application or service in the one or more applications or services.

12. The method of claim 1 wherein identifying the sequence of interactions from the interactions data comprises determining, by the PAS, for each interaction in the sequence of interactions:
information identifying the interaction,
temporal data associated with the interaction,
information identifying an application or service from the one or more applications or services with which the interaction was made, and
context data associated with the interaction.

13. The method of claim 1 further comprising training or fine tuning a ML model to generate the trained ML model, wherein training or fine tuning the ML model comprises:
receiving training interactions data for the second set of one or more users, the training interactions data identifying interactions made by the second set of one or more users with the one or more applications or services;
identifying sequences of interactions from the training interactions data, each sequence in the sequences of interactions comprising a temporally-ordered set of one or more related interactions; and
training the ML model using the multiple sequence of interactions to generate the trained ML model, wherein the trained ML model is trained to predict a next action to be performed for a sequence of interactions and to generate sequences of embeddings for the sequences of interactions.

14. The method of claim 13 wherein the training or fine tuning the ML model further comprises:
storing the sequences of embeddings generated for the sequences of interactions;
identifying information related to a set of target users, wherein the set of target users includes users for whom the ML model is being trained; and
using the information related to the set of target users to train the ML model.

15. The method of claim 1 further comprising:
performing processing by the PAS to determine if the action is to be performed; and
based upon the processing, determining by the PAS, that the action is to be performed only upon receiving input authorizing performance of the action or that the action is to be performed without receiving any user input; and
upon determining that action is to be performed only upon receiving input authorizing performance of the action:
outputting information seeking authorization for performance of the action,
receiving input authorizing performance of the action, and
wherein causing the action to be performed comprises causing the action to be performed upon receiving the input authorizing performance of the action; and
upon determining that the action is to be performed without receiving any user input, the causing the action to be performed comprises causing the action to be performed without receiving any user input.

16. The method of claim 15 wherein performing processing by the PAS to determine if the action is to be performed comprises:
determining, by the PAS, one or more information pieces; and
determining, by the PAS, based upon the one or more information pieces whether the action is to be performed only upon receiving input authorizing performance of the action or that the action is to be performed without receiving any user input; and
wherein the one or more information pieces include at least one of:
user preferences information configured for a user associated with the sequence of interactions, the user preferences information identifying if the action is to be performed only upon receiving user input authorizing performance of the action or if the action is to be performed without receiving any user input;
information identifying a confidence level, wherein the action is to be performed without receiving any user input if a confidence level associated with prediction of the action is above the identified confidence level;
information identifying a risk level associated with the action;
information identifying a permission associated with the action, wherein the permission indicates whether the action is to be performed only upon receiving user input authorizing performance of the action or if the action is to be performed without receiving any user input; or
information identifying a mode of operation of the PAS, wherein the mode indicates whether the action is to be performed only upon receiving user input authorizing performance of the action or if the action is to be performed without receiving any user input.

17. The method of claim 1 wherein causing the action to be performed comprises:
calling, by the PAS, an application programming interface (API) provided by the particular application or by the particular service to cause the action to be performed by the particular application or the particular service.

18. The method of claim 1 further comprising retraining or re-fine-tuning the trained ML model upon occurrence of one or more of the following:
availability of additional user interactions data since the training of the trained ML model,
performance of the trained ML model drops below an acceptable threshold,
the trained ML model is to be trained for a new application or service that was not included in training data used to train the trained ML model,
a change is detected in a pattern of user interactions from user interactions in the training data that was used to train the trained ML model, or
passage of a certain period of time since the trained ML model was previously trained.

19. A system comprising:
a memory storing a set of instructions;
a set of one or more processors configured to execute the set of instructions to perform processing comprising:
receiving interactions data for a first set of one or more users, the interactions data identifying interactions made by the first set of one or more users with one or more applications or services;
identifying a sequence of interactions from the interactions data, the sequence of interactions comprising a temporally-ordered set of one or more related interactions;
using a trained machine learning (ML) model to generate an output that identifies an action to be performed after the one or more interactions in the sequence of interactions, wherein the trained ML model is trained using interactions made by a second set of users with the one or more applications or services; and
performing processing to determine if the action is to be not performed, is to be performed only upon receiving input authorizing performance of the action, or is to be performed without receiving any user input;
not performing the action upon determining that the action is not to be performed;
upon determining that action is to be performed only upon receiving input authorizing performance of the action:
requesting an authorization for performance of the action,
receiving input authorizing performance of the action, and
causing the action to be performed upon receiving the input authorizing performance of the action; and
upon determining that the action is to be performed without receiving any user input:
causing the action to be performed.

20. A non-transitory computer-readable medium storing instructions executable by one or more processors for causing the one or more processors to perform operations comprising:
receiving interactions data for a first set of one or more users, the interactions data identifying interactions made by the first set of one or more users with one or more applications or services;
identifying a sequence of interactions from the interactions data, the sequence of interactions comprising a temporally-ordered set of one or more related interactions;
using a trained machine learning (ML) model to generate an output that identifies an action to be performed after the one or more interactions in the sequence of interactions, wherein the trained ML model is trained using interactions made by a second set of users with the one or more applications or services;
performing processing to determine if the action is to be not performed, is to be performed only upon receiving input authorizing performance of the action, or is to be performed without receiving any user input;
not performing the action upon determining that the action is not to be performed;
upon determining that action is to be performed only upon receiving input authorizing performance of the action:
requesting an authorization for performance of the action,
receiving input authorizing performance of the action, and
causing the action to be performed upon receiving the input authorizing performance of the action; and
upon determining that the action is to be performed without receiving any user input:
causing the action to be performed.
